(19) United States
(12) Patent Application Publication
(10) Pub. No.: US 2026/0212827 A1
(43) Pub. Date: Jul. 23, 2026

(54) STAGE CIRCUIT AND DISPLAY DEVICE INCLUDING THE SAME, AND ELECTRONIC DEVICE

(71) Applicant: Samsung Display Co., Ltd., Yongin-si (KR)

(72) Inventors: Kyung Ho KIM, Yongin-si (KR); Dong Hee SHIN, Yongin-si (KR); Hyeong Seok KIM, Yongin-si (KR); Jung Hwan HWANG, Yongin-si (KR)

(21) Appl. No.: 19/373,937

(22) Filed: Oct. 30, 2025

(30) Foreign Application Priority Data
Jan. 23, 2025 (KR) 10-2025-0010220

(51) Int. Cl. G09G 3/3266

(52) U.S. Cl. CPC G09G 3/3266; G09G 2300/0426; G09G 2310/0286; G09G 2310/08; G09G 2330/023

(57) ABSTRACT

A stage circuit includes a driver controlling voltages of first to fourth nodes, a first driving circuit connected to first and second nodes, and supplying a scan signal to first output terminals based on voltages of first local nodes controlled corresponding to the first node voltage, a second driving circuit connected to the third and fourth nodes, and supplying an initialization signal to second output terminals based on voltages of second local nodes controlled corresponding to the third node voltage, first connectors between the first and first local nodes, second connectors between the third and second local nodes, a first controller controlling the first connectors, a second controller controlling the second connectors, and a first transistor having a first electrode connected to the first and second controllers, and a second electrode connected to a first power input terminal for receiving a first power.

### CROSS-REFERENCE TO RELATED APPLICATION

The present application claims priority to, and the benefit of, Korean Patent Application No. 10-2025-0010220, filed on Jan. 23, 2025, in the Korean Intellectual Property Office, the entire disclosure of which is incorporated herein by reference.

### BACKGROUND

### 1. Field

The present disclosure relates to a stage circuit, a display device including the same, and an electronic device.

### 2. Description of the Related Art

With the development of information technology, the importance of a display device, which is a connection medium between a user and information, is being highlighted. Accordingly, the use of display devices such as a liquid crystal display device, an organic light-emitting display device, and the like is increasing.

The display device includes pixels, and the pixels may receive a data signal in response to a scan signal supplied from a scan driver and emit light with luminance corresponding to the data signal. The scan driver may include a plurality of stage circuits to supply the scan signal.

### SUMMARY

The present disclosure provides a stage circuit capable of reducing or minimizing power consumption and mounting area, a display device including the same, and an electronic device.

A stage circuit according to embodiments of the present disclosure includes a driver configured to control a voltage of a first node, a voltage of a second node, a voltage of a third node, and a voltage of a fourth node, a first driving circuit connected to the first node and to the second node, and configured to supply a scan signal to first output terminals based on voltages of first local nodes configured to be controlled corresponding to the voltage of the first node, a second driving circuit connected to the third node and to the fourth node, and configured to supply an initialization signal to second output terminals based on voltages of second local nodes configured to be controlled corresponding to the voltage of the third node, first connectors in the first driving circuit and respectively between the first node and the first local nodes, second connectors in the second driving circuit and respectively between the third node and the second local nodes, a first controller in the first driving circuit and configured to control the first connectors, a second controller in the second driving circuit and configured to control the second connectors, and a first transistor having a first electrode connected to the first controller and to the second controller, and a second electrode connected to a first power input terminal for receiving a first power.

The driver may include a holding capacitor having a first electrode connected to the first power input terminal, and a third transistor and a fourth transistor connected in series between a first voltage control line in the first driving circuit and a second electrode of the holding capacitor, and having a gate electrode connected to a sampling input terminal for receiving a sampling signal.

A gate electrode of the first transistor may be connected to the second electrode of the holding capacitor.

The stage circuit may further include a second transistor connected between the first power input terminal and a common terminal of the third and fourth transistors, and having a gate electrode connected to a second electrode of the holding capacitor.

The first driving circuit may include the first controller connected to the first power input terminal, to a second power input terminal for receiving a second power, to a first scan carry input terminal for receiving a first scan carry signal, to a second scan carry input terminal for receiving the second scan carry signal, and to an initialization terminal for receiving an initialization control signal, and configured to control a voltage of a first connection control line, a first booster connected to a boosting clock input terminal for receiving a first boosting clock signal and to a third power input terminal for receiving a third power, and configured to control the voltage of the first voltage control line based on the voltage of the first node and the voltage of the second node, a first carry output connected to a scan carry clock input terminal for receiving a first scan carry clock signal and to the third power input terminal, and configured to output a scan carry signal to a first carry output terminal based on the voltage of the first node and the voltage of the second node, first outputs connected to scan clock input terminals for receiving one of scan clock signals and to a fourth power input terminal for receiving a fourth power, and configured to output the scan signal to the first output terminals based on the voltages of the first local nodes and the voltage of the second node, the first connectors configured to control an electrical connection between the first local nodes and the first node based on the voltage of the first connection control line, and a first reset connected between the first connection control line and a fifth power input terminal for receiving a fifth power, and configured to control an electrical connection between the first connection control line and the fifth power input terminal based on the voltage of the second node.

The first controller may further include a control transistor connected between the first connection control line and the first electrode of the first transistor, and having a gate electrode connected to the initialization terminal, a first control transistor connected between the first power input terminal and the first connection control line, and having a gate electrode connected to the first scan carry input terminal, a second control transistor connected between the second power input terminal and the first connection control line, and having a gate electrode connected to the first voltage control line, and a third control transistor connected between the second power input terminal and the first connection control line, and having a gate electrode connected to the second scan carry input terminal.

Each of the first connectors may include a switching transistor connected between one of the first local nodes and the first node, and having a gate electrode connected to the first connection control line, and a boosting capacitor connected between the one of the first local nodes and the first voltage control line.

The first booster may include a first boosting transistor connected between the boosting clock input terminal and the first voltage control line, and having a gate electrode connected to the first node, a second boosting transistor connected between the third power input terminal and the first voltage control line, and having a gate electrode connected to the second node, and a first capacitor connected between the first node and the first voltage control line.

The first carry output may include a first carry transistor connected between the scan carry clock input terminal and the first carry output terminal, and having a gate electrode connected to the first node, and a second carry transistor connected between the first carry output terminal and the third power input terminal, and having a gate electrode connected to the second node.

The first outputs may include a first output transistor connected between a corresponding one of the scan clock input terminals and a corresponding one of the first output terminals, and having a gate electrode connected to a corresponding one of the first local nodes, and a second output transistor connected between the fourth power input terminal and the corresponding one of the first output terminals, and having a gate electrode connected to the second node.

The first reset may include at least one reset transistor connected between the first connection control line and the fifth power input terminal, and having a gate electrode connected to the second node.

The second driving circuit may include the second controller connected to the first power input terminal, to a second power input terminal for receiving a second power, to a first initialization carry input terminal for receiving a first initialization carry signal, to a second initialization carry input terminal for receiving a second initialization carry signal, and to an initialization terminal for receiving an initialization control signal, and configured to control a voltage of a second connection control line, a second booster connected to a boosting clock input terminal for receiving a first boosting clock signal and to a third power input terminal for receiving a third power, and configured to control a voltage of a second voltage control line based on the voltage of the third node and the voltage of the fourth node, a second carry output connected to an initialization carry clock input terminal for receiving a first initialization carry clock signal and to the third power input terminal, and configured to output an initialization carry signal to a second carry output terminal based on the voltage of the third node and the voltage of the fourth node, second outputs connected to initialization clock input terminals for receiving a corresponding one of initialization clock signals and to a fourth power input terminal for receiving a fourth power, and configured to output the initialization signal to the second output terminals based on the voltages of the second local nodes and the voltage of the fourth node, the second connectors configured to control an electrical connection between the second local nodes and the third node based on the voltage of the second connection control line, and a second reset connected between the second connection control line and a fifth power input terminal for receiving a fifth power, and configured to control an electrical connection between the second connection control line and the fifth power input terminal based on the voltage of the fourth node.

The second controller may further include a control transistor connected between the second connection control line and the first electrode of the first transistor, and having a gate electrode connected to the initialization terminal, a first control transistor connected between the first power input terminal and the second connection control line, and having a gate electrode connected to the first initialization carry input terminal, a second control transistor connected between the second power input terminal and the second connection control line, and having a gate electrode connected to the second voltage control line, and a third control transistor connected between the second power input terminal and the second connection control line, and having a gate electrode connected to the second initialization carry input terminal.

The second connectors may include a switching transistor connected between a corresponding one of the second local nodes and the third node, and having a gate electrode connected to the second connection control line, and a boosting capacitor connected between the corresponding one of the second local nodes and the second voltage control line.

The second booster may include a first boosting transistor connected between the boosting clock input terminal and the second voltage control line, and having a gate electrode connected to the third node, a second boosting transistor connected between the third power input terminal and the second voltage control line, and having a gate electrode connected to the fourth node, and a first capacitor connected between the third node and the second voltage control line.

The second carry output may include a first carry transistor connected between the initialization carry clock input terminal and the second carry output terminal, and having a gate electrode connected to the third node, and a second carry transistor connected between the second carry output terminal and the third power input terminal, and having a gate electrode connected to the fourth node.

The second outputs may include a first output transistor connected between a corresponding one of the initialization clock input terminals and a corresponding one of the second output terminals, and having a gate electrode connected to a corresponding one of the second local nodes, and a second output transistor connected between the fourth power input terminal and the corresponding one of the second output terminals, and having a gate electrode connected to the fourth node.

The second reset may include at least one reset transistor connected between the second connection control line and the fifth power input terminal, and having a gate electrode connected to the fourth node.

A display device according to embodiments of the present disclosure includes pixels connected with scan lines, initialization lines, and data lines, and a scan driver including stage circuits configured to provide a scan signal to the scan lines and an initialization signal to the initialization lines during a driving period, and to provide the scan signal to at least one first scan line among the scan lines and the initialization signal to at least one first initialization line among the initialization lines during a sensing period, wherein at least one stage circuit of the stage circuits includes a driver configured to control a voltage of a first node, a voltage of a second node, a voltage of a third node, and a voltage of a fourth node, and including a holding capacitor configured to be charged when an enable scan signal is output from the stage circuit and a sampling signal is input, a first driving circuit configured to output the scan signal, and including first local nodes configured to be controlled based on the voltage of the first node, first connectors respectively connected between the first node and the first local nodes, and a first controller configured to control the first connectors, a second driving circuit configured to output the initialization signal, and including second local nodes configured to be controlled based on the voltage of the third node, second connectors respectively connected between the third node and the second local nodes, and a second controller configured to control the second local nodes, and a first transistor including a first electrode connected to the first controller and to the second controller, a second electrode connected to a first power input terminal, and a gate electrode connected to a second electrode of the holding capacitor.

An electronic device according to embodiments of the present disclosure includes a processor, and a display module configured to display an image based on image data provided from the processor, the display module including pixels connected with scan lines, initialization lines, and data lines, and a scan driver including stage circuits configured to provide a scan signal to the scan lines and an initialization signal to the initialization lines during a driving period, and to provide the scan signal to at least one first scan line among the scan lines and the initialization signal to at least one first initialization line among the initialization lines during a sensing period, wherein at least one stage circuit of the stage circuits includes a driver configured to control a voltage of a first node, a voltage of a second node, a voltage of a third node, and a voltage of a fourth node, and including a holding capacitor configured to be charged when an enable scan signal is output from the stage circuit and a sampling signal is input, a first driving circuit configured to output the scan signal and including first local nodes configured to be controlled based on the voltage of the first node, first connectors respectively connected between the first node and the first local nodes, and a first controller configured to control the first connectors, a second driving circuit configured to output the initialization signal and including second local nodes configured to be controlled based on the voltage of the third node, second connectors respectively connected between the third node and the second local nodes, and a second controller configured to control the second local nodes, and a first transistor including a first electrode connected to the first controller and to the second controller, a second electrode connected to a first power input terminal, and a gate electrode connected to a second electrode of the holding capacitor.

The aspects of the present disclosure are not limited to the above, and other aspects that are not mentioned may be clearly understood by those skilled in the art from the following description.

According to the stage circuit, the display device including the same, and the electronic device according to embodiments of the present disclosure, one stage circuit may drive a plurality of scan lines and a plurality of initialization lines, thereby minimizing or reducing the mounting area.

According to the stage circuit and the display device including the same according to embodiments of the present disclosure, it is possible to reduce or prevent the likelihood of the first power input terminal being electrically connected to the controllers included in the stage circuits that do not output the scan signal (and the initialization signal) during the sensing period, thereby reducing or preventing unnecessary power consumption.

However, aspects of the present disclosure are not limited to the above-described aspects, and may be variously expanded without departing from the spirit and scope of the present disclosure.

### BRIEF DESCRIPTION OF THE DRAWINGS

FIG. 1 is a diagram illustrating a display device according to one or more embodiments of the present disclosure.

FIG. 2 is a circuit diagram illustrating one or more embodiments of a pixel illustrated in FIG. 1.

FIG. 3 is a diagram illustrating one or more embodiments of a scan driver illustrated in FIG. 1.

FIGS. 4A and 4B are block diagrams illustrating an i-th stage circuit illustrated in FIG. 3 according to one or more embodiments of the present disclosure.

FIG. 5 is a diagram illustrating one or more embodiments of a first driving circuit illustrated in FIG. 4A.

FIG. 6 is a diagram illustrating one or more embodiments of a second driving circuit illustrated in FIG. 4B.

FIG. 7 is a waveform diagram illustrating one or more embodiments of a driving method of the first driving circuit illustrated in FIG. 5.

FIGS. 8A to 8C are diagrams illustrating an operation process of the first driving circuit corresponding to the driving waveform of FIG. 7.

FIG. 9 is a waveform diagram illustrating one or more embodiments of a driving method of the second driving circuit illustrated in FIG. 6.

FIG. 10 is a diagram illustrating one or more embodiments of the driver illustrated in FIG. 4A.

FIG. 11 is a waveform diagram illustrating an operation process of the driver illustrated in FIG. 10.

FIG. 12 is a diagram illustrating an electronic device according to one or more embodiments of the present disclosure.

FIGS. 13 to 16 are diagrams illustrating an electronic device according to various embodiments.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection.

For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer, or section described below could be termed a second element, component, region, layer, or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same.” In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

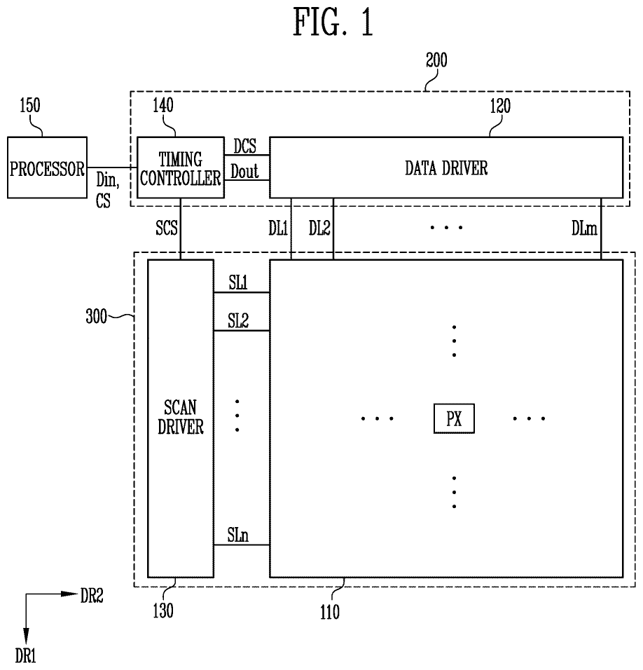

FIG. 1 is a diagram illustrating a display device according to one or more embodiments of the present disclosure.

Referring to FIG. 1, a display device according to one or more embodiments of the present disclosure may include a display driver 200 and a display (e.g., display unit) 300.

The display driver 200 may control the display 300. The display driver 200 may include a timing controller 140 and a data driver 120. The display driver 210 may be composed of one IC or a plurality of ICs. The display 300 may display an image. The display 300 may include a pixel (e.g., pixel unit) 110 and a scan driver 130.

The timing controller 140 may receive input data Din and control signals CS corresponding to each frame from a processor 150. Here, the processor 150 may correspond to a Graphics Processing Unit (GPU), a Central Processing Unit (CPU), an Application Processor (AP), or the like. The control signals CS may include various signals suitable for driving the display device. The input data Din may correspond to the image displayed in the pixel 110.

The timing controller 140 may rearrange the input data Din to meet the specifications of the display device. The timing controller 140 may generate output data Dout by correcting the input data Din, and supply the output data Dout to the data driver 120. For example, the timing controller 140 may generate the output data Dout by correcting the input data Din by reflecting an optical measurement result.

In one or more embodiments, the timing controller 140 may generate a data-driving signal DCS and a scan-driving signal SCS in response to the control signal CS. The data-driving signal DCS may be supplied to the data driver 120, and the scan-driving signal SCS may be supplied to the scan driver 130.

The pixel 110 may include pixels PX positioned to be connected to scan lines SL1, SL2, . . . , and SLn, n is a natural number of 3 or more, and data lines DL1, DL2, . . . , and DLm, m is a natural number of 3 or more.

The data lines DL1 to DLm may be arranged to extend in a first direction DR1. The first direction DR1 may be, for example, a direction connecting an upper side and a lower side of the pixel 110. Alternatively, the first direction DR1 may be a direction connecting the left and right sides of the pixel 110, or may refer to a direction different therefrom.

The scan lines SL1 to SLn may be arranged to extend in the second direction DR2. The second direction DR2 may be a direction orthogonal to the first direction DR1. The second direction DR2 may be a direction connecting the left and right sides of the pixel 110. Alternatively, the second direction DR2 may be a direction connecting the upper side and the lower side of the pixel 110, or may refer to a direction different therefrom.

A plurality of pixels PX may be arranged in the pixel 110 to be electrically connected to the data lines DL1 to DLm and the scan lines SL1 to SLn. Here, the pixels PX may be sub-pixels. For example, the pixels PX may be arranged in a variety of currently known ways.

The pixels PX may be selected in units of horizontal lines (for example, the pixels PX connected to the same scan line may be classified into one horizontal line (or pixel row)) when a scan signal is supplied to the scan lines SL1 to SLn, and the pixels PX selected by the scan signal may receive a data signal from a corresponding data line (either of DL1 to DLm). The pixels PX supplied with the data signal may generate light of a corresponding luminance in response to a voltage of the data signal.

The data driver 120 may receive the output data Dout and the data-driving signal DCS from the timing controller 140. The data driver 120 may generate the data signal based on the data-driving signal DCS and the output data Dout. For example, the data driver 120 may generate an analog data signal based on grayscales in the output data Dout. The data driver 120 may supply the data signal in units of one horizontal period.

The scan driver 130 may receive the scan-driving signal SCS from the timing controller 140.

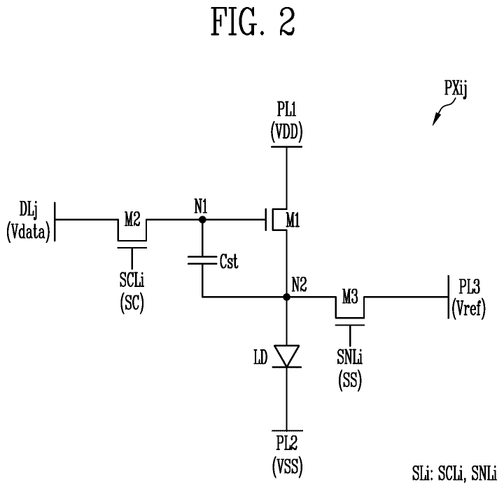

In one or more embodiments, each of the scan lines SL1 to SLn may include a scan line SCL and an initialization line SNL as shown in FIG. 2. The scan driver 130 may sequentially supply scan signals to scan lines SCL in response to the scan-driving signal SCS. The scan driver 130 may sequentially supply initialization signals to initialization lines SNL in response to the scan-driving signal SCS.

In one or more embodiments, the scan driver 130 may be located in the display device as a separate integrated circuit (IC). In one or more embodiments, the scan driver 130 may be formed together with the pixels PX in a process of forming the pixel 110. For example, the scan driver 130 may be formed in the pixel 110 in an OSG (Oxide Semiconductor thin film transistor Gate driver circuit) type or an ASG (Amorphous Silicon thin film transistor Gate driver circuit) type.

In one or more embodiments of the present disclosure, the display device may include a planar display device, a curved display device in which a part of the pixel 110 is bent, a flexible display device in which the part is foldable or bendable, and a stretchable display device in which the part is stretched.

In one or more embodiments of the present disclosure, the display device is a device for displaying a video or a still image, and may include a portable electronic device, such as a mobile phone, a smart phone, a tablet personal computer (PC), a smart watch, a watch phone, a mobile communication terminal, an electronic notebook, an electronic book, a PMP (Portable Multimedia Player), navigation, a UMPC (Ultra Mobile PC), and the like. In one or more embodiments of the present disclosure, the display device may include an electronic device, such as a television, a laptop computer, a monitor, a billboard, or the Internet of Things (IoT).

FIG. 2 is a circuit diagram illustrating one or more embodiments of a pixel illustrated in FIG. 1. In FIG. 2, for convenience of description, a pixel PXij located on an i-th horizontal line (where i is a natural number that is equal to or less than n and equal to or greater than 1) and a j-th vertical line (where j is a natural number that is less than or equal to m and equal to or larger than 1) will be illustrated.

Referring to FIG. 2, a pixel PXij according to one or more embodiments of the present disclosure may include a light-emitting element LD and a pixel circuit for controlling an amount of current supplied to the light-emitting element LD. An i-th scan line SLi may include an i-th scan line SCLi and an i-th initialization line SNLi.

A first electrode (or an anode electrode) of the light-emitting element LD may be connected to a first power line PL1 via a second node N2 and a first transistor M1, and a second electrode (or a cathode electrode) may be connected to a second power line PL2. The light-emitting element LD may generate light of a corresponding luminance in response to an amount of current supplied from the first transistor M1.

A first driving power VDD may be supplied to the first power line PL1, and a second driving power VSS may be supplied to a second power line PL2. During a period in which the pixel PXij emits light, the first driving power VDD may have a higher voltage value than the second driving power VSS.

The light-emitting element LD may be selected as an organic light-emitting diode. The light-emitting element LD may also be selected from inorganic light-emitting diodes, such as a micro light-emitting diode (LED), a quantum dot light-emitting diode. The light-emitting element LD may be an element in which an organic material and an inorganic material are combined. Although FIG. 2 illustrates that the pixel PXij includes a single light-emitting element LD, in one or more other embodiments, the pixel PXij may include a plurality of light-emitting elements, and the plurality of light-emitting elements may be connected in series, in parallel, or in series and parallel to each other.

The pixel circuit may include a first transistor M1, a second transistor M2, a third transistor M3, and a storage capacitor Cst.

A first electrode of the first transistor M1 may be connected to the first power line PL1, and a second electrode of the first transistor M1 may be connected to a second node N2. Here, being connected may include the meaning of being electrically connected. A gate electrode of the first transistor M1 may be connected to the first node N1. The first transistor M1 can control the amount of current supplied from the first power line PL1 to the second power line PL2 via the light-emitting element LD in response to a voltage of the first node N1.

The second transistor M2 may be connected between a j-th data line DLj and the first node N1. A gate electrode of the second transistor M2 may be electrically connected to the i-th scan line SCLi. The second transistor M2 may be turned on to electrically connect the j-th data line DLj and the first node N1 when an enable scan signal SC is supplied to the i-th scan line SCLi. When the second transistor M2 is turned on, a data signal from the j-th data line DLj may be supplied to the first node N1.

A scan signal SC may have a gate-on voltage (e.g., enabled) or a gate-off voltage (e.g., disabled). Thereafter, an enable scan signal SC may mean that the gate-on voltage is supplied to the i-th scan line SCLi, and a disable scan signal SC may mean that the gate-off voltage is supplied to the i-th scan line SCLi.

The third transistor M3 may be connected between the second node N2 and a third power line PL3. A gate electrode of the third transistor M3 may be electrically connected to the i-th initialization line SNLi. The third transistor M3 may be turned on to electrically connect the second node N2 and the third power line PL3 when an enable initialization signal SS is supplied to the i-th initialization line SNLi. When the third transistor M3 is turned on, a voltage of a reference power Vref from the third power line PL3 may be supplied to the second node N2.

The reference power Vref may be supplied to the third power line PL3. The voltage of the reference power Vref may be set such that the light-emitting element LD is turned off when the reference power Vref is supplied to the second node N2. A voltage difference between the reference power Vref and the second driving power VSS may be smaller than a threshold voltage of the light-emitting element LD. For example, the voltage of the reference power Vref may be set to be the same as or similar to a voltage of the second driving power VSS.

An initialization signal SS may have a gate-on voltage (e.g., enabled) or a gate-off voltage (e.g., disabled). Thereafter, an enable initialization signal SS may mean that the gate-on voltage is supplied to the i-th initialization line SNLi, and a disable initialization signal SS may mean that the gate-off voltage is supplied to the i-th initialization line SNLi.

Although the first transistor M1 to the third transistor M3 are illustrated as N-type transistors in FIG. 2, one or more embodiments of the present disclosure is not limited thereto. For example, at least one among the first transistor M1 to the third transistor M3 may be implemented as a P-type transistor.

The storage capacitor Cst may be connected between the first node N1 and the second node N2. The storage capacitor Cst may store a voltage corresponding to the data signal. For example, the storage capacitor Cst may store a voltage corresponding to a difference between the data signal supplied to the first node N1 and the reference power Vref supplied to the second node N2.

In one or more embodiments of the present disclosure, a structure of the pixel PXij is not limited to the one or more embodiments corresponding to FIG. 2. For example, the pixel PXij may be implemented with various types of circuits that are currently known.

Briefly describing an operation process, the enable scan signal SC and the enable initialization signal SS may be sequentially supplied to each of the scan lines SL1 to SLn during a driving period. The enable scan signal SC supplied to the i-th scan line SCLi may be supplied to be synchronized with the enable initialization signal SS supplied to the i-th initialization line SNLi.

When the enable initialization signal SS is supplied to the i-th initialization line SNLi, the third transistor M3 may be turned on, and the voltage of the reference power Vref may be supplied to the second node N2. When the enable scan signal SC is supplied to the i-th scan line SCLi, the second transistor M2 may be turned on, and the data signal may be supplied to the first node N1. In this case, a voltage corresponding to a difference between the data signal and the reference power Vref may be stored in the storage capacitor Cst.

The second transistor M2 may be turned off by the disable scan signal SC supplied to the i-th scan line SCLi, and the third transistor M3 may be turned on by the disable initialization signal SS supplied to the i-th initialization line SNLi. The first transistor M1 may supply a corresponding driving current to the light-emitting element LD in response to a voltage stored in the storage capacitor Cst, and the light-emitting element LD may generate light having a luminance corresponding to the driving current.

During a sensing period, the enable scan signal SC and the enable initialization signal SS synchronized with the enable scan signal SC may be supplied to at least one among the scan lines SL1 to SLn. At least one among the scan lines SL1 to SLn to which the enable scan signal SC and the enable initialization signal SS are supplied in the sensing period may be randomly set for each sensing period.

In one or more embodiments, the enable initialization signal SS may be supplied to the i-th initialization line SNLi and an enable scan signal SC may be supplied to the i-th scan line SCLi during a sensing period. The third transistor M3 may be turned on in response to the enable initialization signal SS supplied to the i-th initialization line SNLi, and the voltage of the reference power Vref may be supplied to the second node N2.

When the enable scan signal SC is supplied to the i-th scan line SCLi, the second transistor M2 may be turned on, and a preset reference data signal may be supplied to the first node N1. The reference data signal may have a preset voltage so that characteristics of the pixels PX may be sensed. A voltage corresponding to a difference between the reference data signal and the reference power Vref may be stored in the storage capacitor Cst.

The second transistor M2 may be turned off by the disabled scan signal SC supplied to the i-th scan line SCLi. In this case, the third transistor M3 is maintained in a turn-on state, and the third power line PL3 may be electrically connected to the timing controller 140 (in this case, the voltage of the reference power Vref is not supplied to the third power line PL3).

Then, a current supplied from the first transistor M1 in response to the reference data signal may be supplied to the timing controller 140 via the second node N2 and the third transistor M3, and the timing controller 140 may control the output data Dout to compensate for a threshold voltage and/or mobility of the first transistor M1, and/or a degradation of the light-emitting element LD in response to the current (or voltage) supplied from the second node N2.

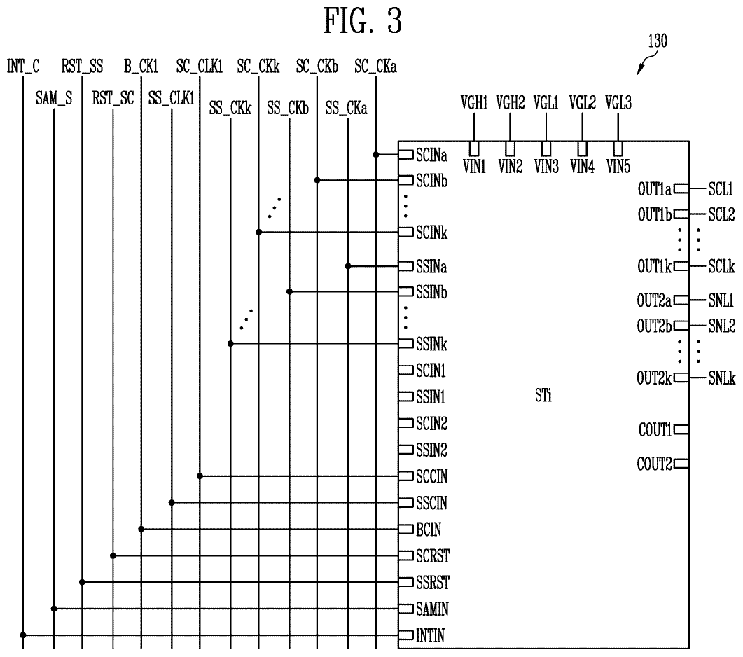

FIG. 3 is a diagram illustrating one or more embodiments of a scan driver illustrated in FIG. 1. The scan driver 130 includes a plurality of stage circuits, and FIG. 3 illustrates an i-th stage circuit STi for convenience of description. For example, the i-th stage circuit STi may be a first stage circuit.

Referring to FIG. 3, the i-th stage circuit STi may be connected to a plurality of scan lines SCL1, SCL2, . . . , and SCLk (where k is a natural number of 2 or more), and a plurality of initialization lines SNL1, SNL2, . . . , and SNLk.

In one or more embodiments, the i-th stage circuit STi may be connected to the k scan lines SCL1 to SCLk, and may supply a scan signal to the k scan lines SCL1 to SCLk. The i-th stage circuit STi may be connected to k initialization lines SNL1 to SNLK, and may supply an initialization signal to the k initialization lines SNL1 to SNLk. That is, in one or more embodiments of the present disclosure, a plurality of scan lines SCL1 to SCLk and a plurality of initialization lines SNL1 to SNLk may be driven using one stage circuit, and thus mounting area of the scan driver 130 may be minimized or reduced.

In one or more embodiments, the i-th stage circuit STi may include first output terminals OUT1a, OUT1b, . . . , and OUT1k, and second output terminals OUT2a, OUT2b, . . . , and OUT2k.

Each of the first output terminals OUT1a to OUT1k may be respectively electrically connected to the scan lines SCL1 to SCLk. Each of the first output terminals OUT1a to OUT1k may respectively supply an enable scan signal receiving from the i-th stage circuit STi to the scan lines SCL1 to SCLk connected thereto.

Each of the second output terminals OUT2a to OUT2k may be respectively electrically connected to the initialization lines SNL1 to SNLk. Each of the second output terminals OUT2a to OUT2k may supply an enable initialization signal receiving from the i-th stage circuit STi to the anyone among the initialization lines SNL1 to SNLk connected thereto.

In one or more embodiments, the i-th stage circuit STi may include power input terminals VIN1, VIN2, VIN3, VIN4, and VIN5, scan clock input terminals SCINa, SCINb, . . . , and SCINk, initialization clock input terminals SSINa, SSINb, . . . , and SSINk, carry input terminals SCIN1, SCIN2, SSIN1, and SSIN2, a scan carry clock input terminal SCCIN, an initialization carry clock input terminal SSCIN, a boosting clock input terminal BCIN, a scan reset input terminal SCRST, an initialization reset input terminal SSRST, a sampling input terminal SAMIN, an initialization terminal INTIN, and carry output terminals COUT1 and COUT2.

The first power input terminal VIN1 may receive a voltage of a first power VGH1. The first power VGH1 may have a positive voltage, for example, a logic high level voltage. The logic high level voltage may mean a voltage level at which a transistor supplied with the logic high level voltage is turned on. For example, the first power VGH1 may have a voltage of about 25 V.

The second power input terminal VIN2 may receive a voltage of a second power VGH2. The second power VGH2 may have a positive voltage, for example, a logic high level voltage or a logic low level voltage. The logic low level voltage may mean a voltage level at which a transistor supplied with the logic low level voltage is turned off. The transistor to which the second power VGH2 is supplied to a gate electrode may be turned on or off based on the voltage of a first electrode (or second electrode) of the transistor. In one or more embodiments, the second power VGH2 may have a lower voltage than the first power VGH1, and may have a voltage of about 15 V, for example.

The third power input terminal VIN3 may receive a voltage of a third power VGL1. The third power VGL1 may be a negative voltage, and may have a logic low level voltage. The third power VGL1 may have a voltage lower than that of the second power VGH2, and may have a voltage of about −9 V, for example.

The fourth power input terminal VIN4 may receive a voltage of a fourth power VGL2. The fourth power VGL2 may be a negative voltage, and may have a logic low level voltage. The fourth power VGL2 may have a voltage lower than that of the second power VGH2 and higher than that of the third power VGL1, for example, a voltage of about −5 V.

The fifth power input terminal VIN5 may receive a voltage of a fifth power VGL3. The fifth power VGL3 may be a negative voltage, and may have a logic low level voltage. The fifth power VGL3 may be set to various voltages. For example, the fifth power VGL3 may be set to the same voltage as the fourth power VGR2, and in this case, the fifth power input terminal VIN5 may be replaced with the fourth power input terminal Vin4.

Each of the scan clock input terminals SCINa to SCINk may respectively receive the scan clock signals SC_CKa, SC_CKb, . . . , and SC_CKk. The scan clock signals SC_CKa to SC_CKk may be respectively supplied to the first output terminals OUT1a to OUT1k, and the scan clock signals SC_CKa to SC_CKk supplied to the first output terminal OUT1a and OUT1k may be supplied as the enable scan signal SC to the scan lines SCL1 to SCLK.

Each of the initialization clock input terminals SSINa to SSINK may respectively receive initialization clock signals SS_CKa, SS_CKb, . . . , and SS_CKk. The initialization clock signals SS_CKa to SS_CKk may be respectively supplied to the second output terminals OUT2a to OUT2k, and the initialization clock signals SS_CKa to SS_CKk supplied to the second output terminal OUT2a and OUT2k may be supplied as the enable initialization signal SS to the initialization lines SNL1 to SNLk.

In one or more embodiments, scan clock signals (e.g., SC_CKa, SC_CKb, . . . , and SC_CKk) and initialization clock signals (e.g., SS_CKa, SS_CKb, . . . , and SS_CKk) supplied to an odd-numbered stage circuit may be different from the scan clock signals and the initialization clock signals supplied to an even-numbered stage circuit. For example, scan clock signals and initialization clock signals having a preset phase difference may be supplied to the odd-numbered stage circuit and the even-numbered stage Circuit. However, the present disclosure is not limited thereto, and for example, at least some of the scan clock signals and at least some of the initialization clock signals supplied to the odd-numbered and even-numbered stage circuits may be shared.

The carry input terminals SCIN1, SSIN1, SCIN2, and SSIN2 may receive a carry signal from a previous stage circuit and a next stage circuit.

In one or more embodiments, the first scan carry input terminal SCIN1 may receive an (i−1)-th scan carry signal from the previous stage circuit, the second scan carry input terminal SCIN2 may receive an (i+1)-th scan carry signal from the next stage circuit, the first initialization carry input terminal SSIN1 may receive an (i−1)-th initialization carry signal from the previous stage circuit, and the second initialization carry input terminal SSIN2 may receive an (i+1)-th initialization carry signals from the next stage circuit.

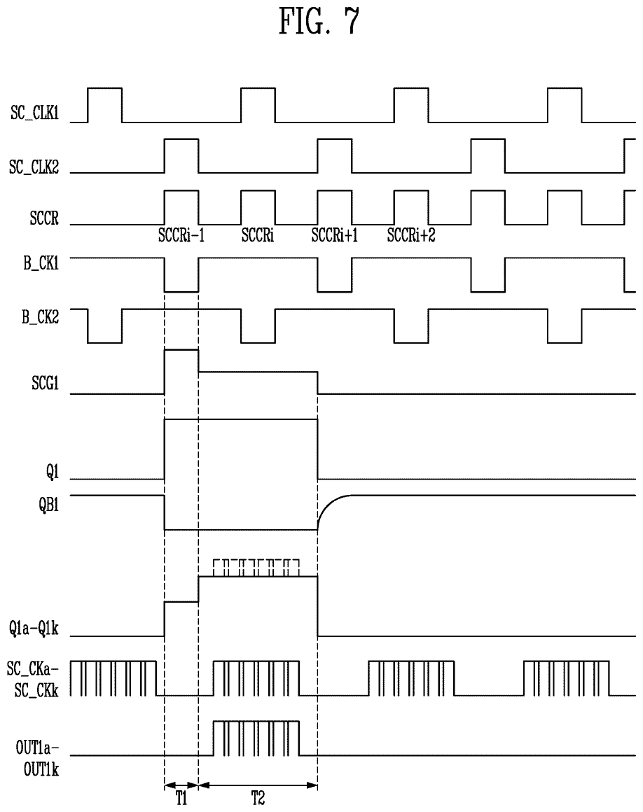

The scan carry clock input terminal SCCIN may receive a first scan carry clock signal SC_CLK1. For example, the scan carry clock input terminal SCCIN included in the odd-numbered stage circuit may receive the first scan carry clock signal SC_CLK1, and the scan carry clock input terminal SCCIN included in the even-numbered stage circuit may receive a second scan carry clock signal SC_CLK2 (see FIG. 7). The first scan carry clock signal SC_CLK1 and the second scan carry clock signals SC_CLK2 may have the same period and different phases as shown in FIG. 7. For example, the first scan carry clock signal SC_CLK1 and the second scan carry clock signal SC_CLK2 may have a phase difference of 180 degrees.

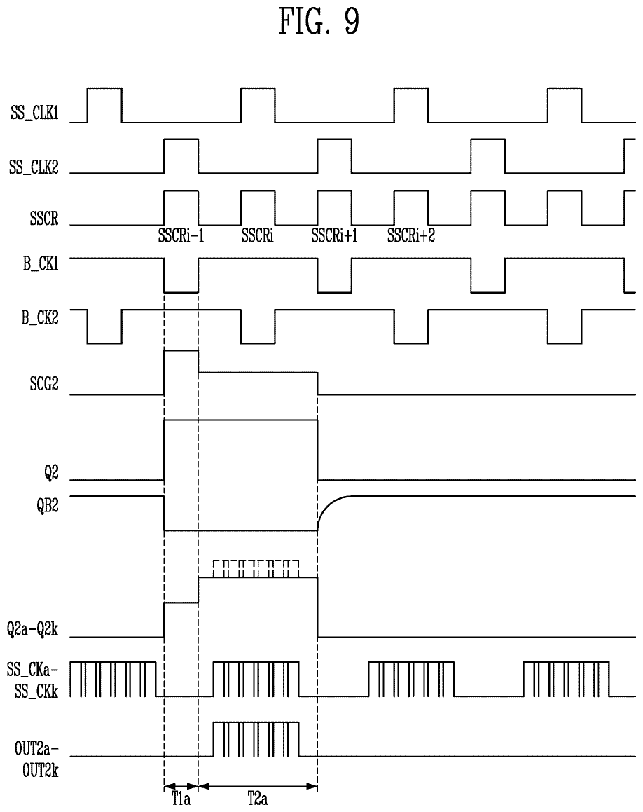

The initialization carry clock input terminal SSCIN may receive a first initialization carry clock signal SS_CLK1. For example, the initialization carry clock input terminal SSCIN included in the odd-numbered stage circuit may receive the first initialization carry clock signal SS_CLK1, and the initialization carry clock input terminal SSCIN included in the even-numbered stage circuit may receive a second initialization carry clock signal SS_CLK2 (see FIG. 9). The first initialization carry clock signal SS_CLK1 and the second initialization carry clock signal SS_CLK2 may have the same period and different phases as shown in FIG. 9. For example, the first initialization carry clock signal SS_CLK1 and the second initialization carry clock signal SS_CLK2 may have a phase difference of 180 degrees.

The boosting clock input terminal BCIN may receive a first boosting clock signal B_CK1. For example, the boosting clock input terminal BCIN included in the odd-numbered stage circuit may receive the first boosting clock signal B_CK1, and the boosting clock input terminal BCIN included in the even-numbered stage circuit may receive a second boosting clock signal B_CK2 (see FIG. 7). The first boosting clock signal B_CK1 and the second boosting clock signal B_CK2 may have the same period and different phases, as shown in FIG. 7. For example, the first boosting clock signal B_CK1 and the second boosting clock signalB_CK2 may have a phase difference of 180 degrees.

The scan reset input terminal SCRST may receive a scan reset signal RST_SC. The scan reset signal RST_SC may be commonly supplied to all stage circuits, and may be used to reset a first driving circuit included in the stage circuits and generating the scan signal.

The initialization reset input terminal SSRST may receive an initialization reset signal RST_SS. The initialization reset signal RST_SS may be commonly supplied to all stage circuits, and may be used to reset a second driving circuit included in the stage circuits and generating the initialization signal.

The sampling input terminal SAMIN may receive a sampling signal SAM_S. The sampling signal SAM_S may be supplied during the driving period, and may be a signal for selecting a stage circuit (or a scan line and an initialization line) to which the scan signal SC and the initialization signal SS are to be supplied during the sensing period.

The initialization terminal INTIN may receive an initialization control signal INT_C. The initialization control signal INT_C may be supplied during the sensing period, and may be a signal that enables the scan signal SC and the initialization signal SS to be supplied in the stage circuit selected by the sampling signal SAM_S.

Here, the scan reset signal RST_SC, the initialization reset signal RST_SS, the sampling signal SAM_S, and the initialization control signal INT_C may be global signals commonly supplied to all stage circuits. When the scan reset signal RST_SC, the initialization reset signal RST_SS, the sampling signal SAM_S, or the initialization control signal INT_C is supplied, all the stage circuits may receive the scan reset signal RST_SC, the initialization reset signal RST_SS, the sampling signals SAM_S or the initialization control signals INT_C.

The first carry output terminal COUT1 may output a scan carry signal. The first carry output terminal COUT1 included in the i-th stage circuit STi may output an i-th scan carry signal.

The second carry output terminal COUT2 may output an initialization carry signal. The second carry output terminal COUT2 included in the i-th stage circuit STi may output an i-th initialization carry signal.

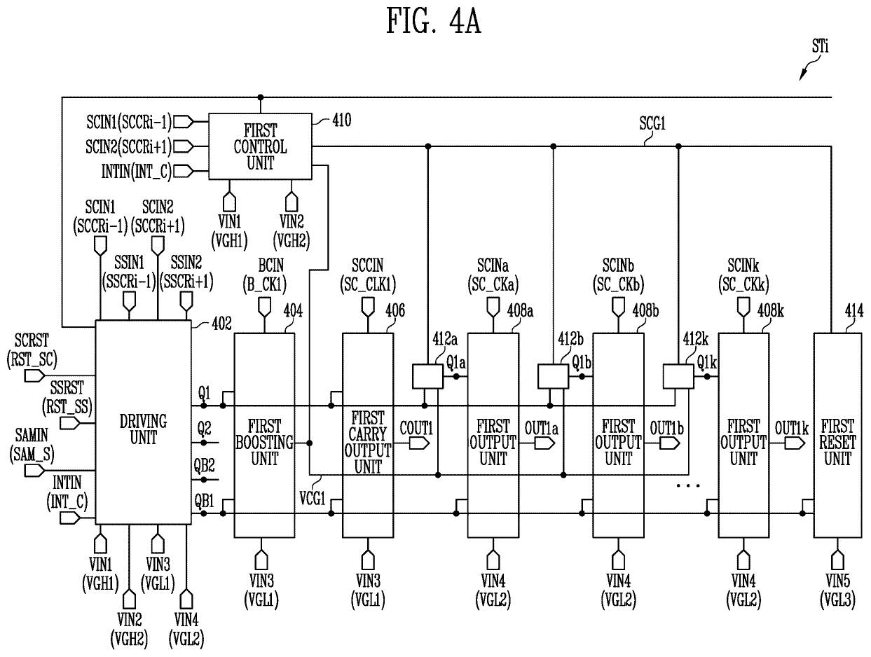

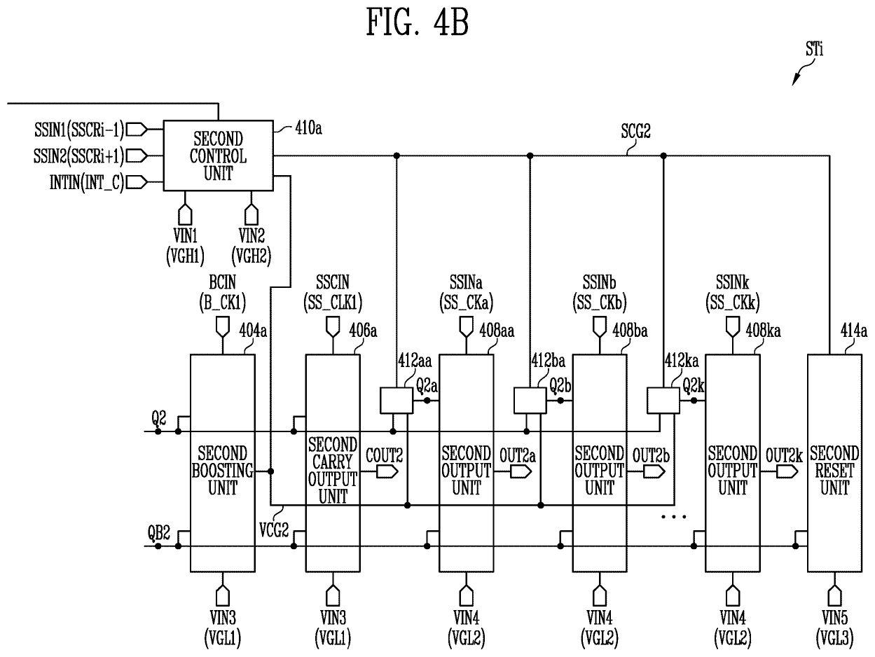

FIGS. 4A and 4B are block diagrams illustrating an i-th stage circuit illustrated in FIG. 3 according to one or more embodiments of the present disclosure.

Referring to FIGS. 4A and 4B, a stage circuit STi according to one or more embodiments of the present disclosure may include a driver (e.g., a driving unit) 402, a first booster (e.g., first boosting unit) 404, a first carry output (e.g., first carry output unit) 406, first outputs (e.g., first output units) 408a, 408b, . . . , and 408k, first connectors (e.g., first connection units) 412a, 412b, . . . , and 412k, a first reset (e.g., first reset unit) 414, a second booster (e.g., second boosting unit) 404a, a second carry output (e.g., second carry output unit) 406a, second outputs (e.g., second output units) 408aa, 408ba, . . . , and 408ka, second connectors (e.g., second connection units) 412aa, 412ba, . . . , and 412ka, and a second reset (e.g., second reset unit) 414a.

The driver 402 may be connected to the first power input terminal VIN1, the second power input terminal VIN2, the third power input terminal VIN3, the fourth power input terminal VIN4, the first scan carry input terminal SCIN1, the second scan carry input terminal SCIN2, the first initialization carry input terminal SSIN1, the second initialization carry input terminal SSIN2, the scan reset input terminal SCRST, the initialization reset input terminal SSRST, the sampling input terminal SAMIN, and the initialization terminal INTIN.

The driver 402 may control voltages of a first node Q1, a second node QB1, a third node Q2, and a fourth node QB2. The first node Q1 and the second node QB1 may be nodes for controlling the first booster 404, the first carry output 406, the first outputs 408a to 408k, the first connectors 412a to 412k, and the first reset 414. The first booster 404, the first carry output 406, the first outputs 408a to 408k, the first connectors 412a to 412k, and the first reset 414 controlled by the voltages of the first node Q1 and the second node QB1 may be referred to as a first driving circuit.

The third node Q2 and the fourth node QB2 may be nodes for controlling the second booster 404a, the second carry output 406a, the second outputs 408aa to 408ka, the second connectors 412aa to 412ka, and the second reset 414a. The second booster 404a, the second carry output 406a, the second outputs 408aa to 408ka, the second connectors 412aa to 412ka, and the second reset 414a controlled by the voltages of the third node Q2 and the fourth node QB2 may be referred to as a second driving circuit.

The first carry output 406 may be connected to the scan carry clock input terminal SCCIN, the third power input terminal VIN3, and the first carry output terminal COUT1. The first carry output 406 may output a scan carry signal to the first carry output terminal COUT1 in response to the voltages of the first node Q1 and the second node QB1.

The first booster 404 may be connected to the boosting clock input terminal BCIN, the third power input terminal VIN3, and a first voltage control line VCG1. The first booster 404 may output a first boosting signal to the first voltage control line VCG1 in response to the voltages of the first node Q1 and the second node QB1. The first voltage control line VCG1 may be electrically connected to the first connectors 412a to 412k.

Each of the first outputs 408a to 408k may be respectively connected to the scan clock input terminals SCINa to SCINk, respectively connected to the first output terminals OUT1a to OUT1k, and connected to the fourth power input terminal VIN4. Each of the first outputs 408a to 408k may be connected to the first node Q1 via a respective one of the first local nodes Q1a, Q1b, . . . , and Q1k and a respective one of the first connectors 412a to 412k. The first outputs 408a to 408k may supply the enable scan signal SC to the first output terminals OUT1a to OUT1k based on a voltage of the first local nodes Q1a to Q1k (or the first node Q1).

Each of the first connectors 412a to 412k may be connected between the first node Q1 and the first local nodes Q1a to Q1k. The first connectors 412a to 412k may electrically connect the first node Q1 and the first local nodes Q1a to Q1k during a first period T1 (see FIG. 7) of a period in which the first node Q1 has a first level (e.g., a high level voltage), and electrically disconnect the first node Q1 and the first local node Q1a to Q1k during a second period T2 (see FIG. 7) of the period in which the first node Q1 has the first level.

The second period T2 may be a period in which the enable scan signal SC is output from the first outputs 408a to 408k. The first connectors 412a to 412k may electrically block the first node Q1 and the first local nodes Q1a to Q1k during a period in which the enable scan signal SC is output from the first outputs 408a to 408k, thereby reducing or preventing luminance deviation in units of horizontal lines.

For example, in case that the first node Q1 and the first local nodes Q1a to Q1k are electrically connected during the second period T2 in which the enable scan signal SC is output from the first outputs 408a to 408k, the voltage of the first node Q1 may be changed. For example, the voltage of the first node Q1 may be changed based on the supply order of enable scan signals SC and based on whether the enable scan signals SC overlap.

When the voltage of the first node Q1 is changed, the voltages of the first local nodes Q1a to Q1k may be changed. When the voltage of the first local nodes Q1a to Q1k is changed during the second period T2, enable scan signals SC having different voltages may be output form the first outputs 408a to 408k, thereby generating a luminance difference in units of horizontal lines.

In one or more embodiments of the present disclosure, the first outputs 408a to 408k and the first node Q1 may be electrically cut off during the second period T2 in which the enable scan signal SC is output by using the first connectors 412a to 412k, and thus a luminance difference in units of horizontal lines can be reduced or prevented.

For example, a voltage of the first local node Q1a may be changed when the enable scan signal SC is output from the first output 408a, a voltage of the first local node Q1b may be changed when the enable scan signal SC is output from the first output 408b, and a voltage of the first local node Q1k may be changed when the first scan signal SC is output from the first output 408k. Here, a voltage change amount of the first local nodes Q1a to Q1k may be substantially the same, and thus the first outputs 408a to 408k may output the enable scan signal SC having substantially the same voltage.

The first controller (e.g., first control unit) 410 may be connected to the first connectors 412a to 412k via a first connection control line SCG1. The first controller 410 may be connected to the first scan carry input terminal SCIN1, the second scan carry input terminal SCIN2, the initialization terminal INTIN, the first power input terminal VIN1, and the second power input terminal VIN2. The first controller 410 may control a voltage of the first connection control line SCG1 based on scan carry signals SCCRi−1 and SCCRi+1 input to the first scan carry input terminal SCIN1 and the second scan carry input terminal SCIN2. The first controller 410 may control the voltage of the first connection control line SCG1 based on an initialization control signal INT_C input to the initialization terminal INTIN.

The first connectors 412a to 412k may control an electrical connection between the first local nodes Q1a to Q1k and the first node Q1 in response to the voltage of the first connection control line SCG1. For example, the first connectors 412a to 412k may electrically connect the first local nodes Q1a to Q1k and the first node Q1 when the first connection control line SCG1 has a logic high level voltage, and electrically disconnect the first local nodes Q1a to Q1k and the first node Q1 when the second connection control line SCC1 has a logic low level voltage.

The first reset 414 may be connected to the first connection control line SCG1 and the fifth power input terminal VIN5. The first reset 414 may control an electrical connection between the first connection control line SCG1 and the fifth power input terminal VIN5 based on a voltage of the second node QB1. For example, the first reset 414 may supply a voltage of the fifth power VGL5 (or a logic low level voltage) to the first connection control line SCG1 based on the voltage of the second node QB1.

The second carry output 406a may be connected to the initialization carry clock input terminal SSCIN, the third power input terminal VIN3, and the second carry output terminal COUT2. The second carry output 406a may output an initialization carry signal to the second carry output terminal COUT2 in response to voltages of the third node Q2 and the fourth node QB2.

The second booster 404a may be connected to the boosting clock input terminal BCIN, the third power input terminal VIN3, and the second voltage control line VCG2. The second booster 404a may output a second boosting signal to the second voltage control line VCG2 in response to voltages of the third node Q2 and the fourth node QB2. The second voltage control line VCG2 may be electrically connected to the second connectors 412aa to 412ka.

Each of the second outputs 408aa to 408ka may be respectively connected to the initialization clock input terminals SSINa to SSINK, respectively connected to the second output terminals OUT2a to OUT2k, and connected to the fourth power input terminal VIN4. Each of the second outputs 408aa to 408ka may be connected to the third node Q2 via a respective one of the second local nodes Q2a, Q2b, . . . , and Q2k and a respective one of the second connectors 412aa to 412ka. The second outputs 408aa to 408ka may supply the enable initialization signal SS to the second output terminals OUT2a to OUT2k based on a voltage of the second local nodes Q2a to Q2k (or the third node Q2).

Each of the second connectors 412aa to 412ka may be connected between the third node Q2 and the second local nodes Q2a to Q2k. The second connectors 412aa to 412ka may electrically connect the third node Q2 and the second local nodes Q2a to Q2k during a first period T1a (see FIG. 9) of a period in which the third node Q2 has a first level (e.g., a high level voltage), and electrically disconnect the third node Q2 and the second local nodes Q2a to Q2k during a second period T2a (see FIG. 9) of the period in which the second node Q2 has the first level.

The second period T2a may be a period in which the enable initialization signal SS is output from the second outputs 408aa to 408ka. The second connectors 412aa to 412ka may electrically block the third node Q2 and the second local nodes Q2a to Q2k during a period in which the enable initialization signal SS is output from the second outputs 408aa to 408ka, so that luminance deviation in units of horizontal lines may be reduced or prevented.

For example, when the third node Q2 and the second local nodes Q2a to Q2k are electrically connected during the second period T2a in which the enable initialization signal SS is output from the second outputs 408aa to 408ka, a voltage of the third node Q1 may be changed. For example, the voltage of the third node Q2 may be changed based on the supply order of enable initialization signals SS and whether the enable initialization signals SS overlap.

When the voltage of the third node Q2 is changed, the voltages of the second local nodes Q2a to Q2k may be changed. When the voltage of the second local nodes Q2a to Q2k is changed during the second period T2a, enable initialization signals SS having different voltages may be output from the second outputs 408aa to 408ka, thereby generating a luminance difference in units of horizontal lines.

In one or more embodiments of the present disclosure, the second connectors 412aa to 412ka are used to electrically block the second outputs 408aa to 408ka and the third node Q2 during the second period T2a in which the enable initialization signal SS is output, thereby reducing or preventing a luminance difference in units of horizontal lines.

For example, a voltage of the second local node Q2a may be changed when the enable initialization signal SS is output from the second output 408aa, a voltage of a second local node Q1b may be changed when the enable initialization signal SS is output from the first output 408b, and a voltage of the first local node Q2k may be changed when the enable initialization signal SS is output from the second output 409ka. Here, a voltage change amount of the second local nodes Q2a to Q2k may be substantially the same, and thus the second outputs 408aa to 408ka may output the enable initialization signal SS having substantially the same voltage.

A second controller (e.g., second control unit) 410a may be connected to the second connectors 412aa to 412ka via a second connection control line SCG2. The second controller 410a may be connected to the first initialization carry input terminal SSIN1, the second initialization carry input terminal SSIN2, the initialization terminal INTIN, the first power input terminal VIN1, and the second power input terminal VIN2. The second controller 410a may control the voltage of the second connection control line SCG2 based on the initialization carry signals SSCRi−1 and SSCRi+1 input to the first initialization carry input terminal SSIN1 and the second initialization carry input terminal SSIN2. The second controller 410a may control the voltage of the second connection control line SCG2 based on the initialization control signal INT_C input to the initialization terminal INTIN.

The second connectors 412aa to 412ka may control an electrical connection between the second local nodes Q2a to Q2k and the third node Q2 in response to the voltage of the second connection control line SCG2. For example, the second connectors 412aa to 412ka may electrically connect the second local nodes Q2a to Q2k and the third node Q2 when the second connection control line SCG2 has a logic high level voltage, and electrically block the second local nodes Q2a to Q1k and the third node Q2 when the second connection control line SCG2 has a logic low level voltage.

The second reset 414a may be connected to the second connection control line SCG2 and the fifth power input terminal VIN5. The second reset 414a may control an electrical connection between the second connection control line SCG2 and the fifth power input terminal VIN5 based on a voltage of the fourth node QB2. For example, the second reset 414a may supply a voltage of the fifth power VGL3 (or a logic low level voltage) to the second connection control line SCG2 based on the voltage of the fourth node QB2.

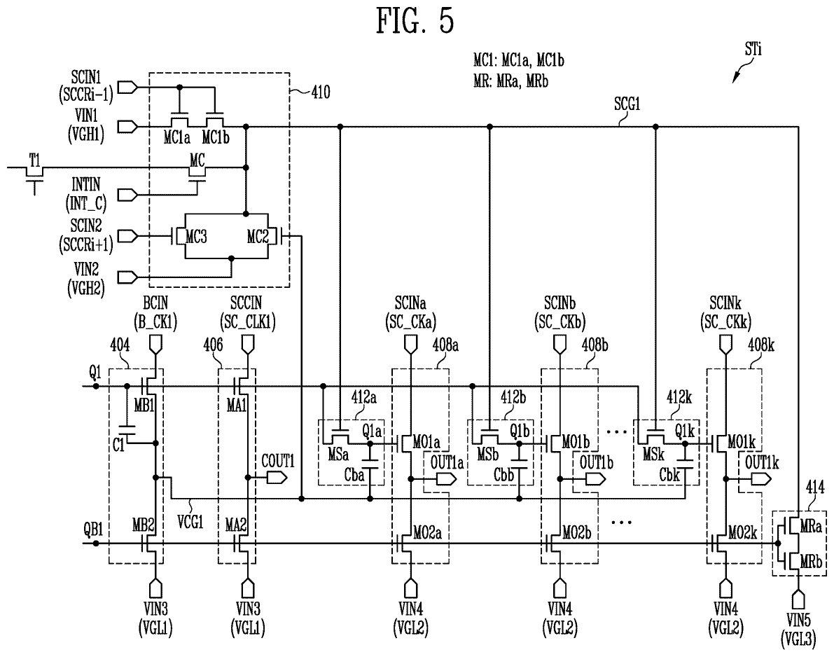

FIG. 5 is a diagram illustrating one or more embodiments of a first driving circuit illustrated in FIG. 4A.

Referring to FIG. 5, the first driving circuit may include a first controller 410, a first booster 404, a first carry output 406, first outputs 408a to 408k, first connectors 412a to 412k, and a first reset 414.

The first booster 404 may electrically connect the first voltage control line VCG1 to the boosting clock input terminal BCIN or the third power input terminal VIN3 in response to the voltages of the first node Q1 and the second node QB1. When a first boosting clock signal B_CK1 is supplied to the first voltage control line VCG1, the first boosting signal may be output. The first boosting signal supplied to the first voltage control line VCG1 may boost the voltages of the first node Q1 and the first local nodes Q1a, Q1b, . . . , and Q1k.

The first booster 404 may include a first boosting transistor MB1, a second boosting transistor MB2, and a first capacitor C1.

The first boosting transistor MB1 may be connected between the boosting clock input terminal BCIN and the first voltage control line VCG1, and a gate electrode of the first boosting transistor MB1 may be connected to the first node Q1. The first boosting transistor MB1 may control an electrical connection between the boosting clock input terminal BCIN and the first voltage control line VCG1 based on the voltage of the first node Q1.

The second boosting transistor MB2 may be connected between the first voltage control line VCG1 and the third power input terminal VIN3, and a gate electrode of the second boosting transistor MB2 may be connected to the second node QB1. The second boosting transistor MB2 may control an electrical connection between the first voltage control line VCG1 and the third power input terminal VIN3 in response to the voltage of the second node QB1.

The first carry output 406 may electrically connect the first carry output terminal COUT1 to the scan carry clock input terminal SCCIN or the third power input terminal VIN3 in response to voltages of the first node Q1 and the second node QB1. When the first scan carry clock signal SC_CLK1 is output to the first carry output terminal COUT1, a scan carry signal (e.g., an i-th scan carry signal) may be output.

The first carry output 406 may include a first carry transistor MA1 and a second carry transistor MA2.

The first carry transistor MA1 may be connected between the scan carry clock input terminal SCCIN and the first carry output terminal COUT1, and a gate electrode of the first carry transistor MA1 may be connected to the first node Q1. The first carry transistor MA1 may control an electrical connection between the scan carry clock input terminal SCCIN and the first carry output terminal COUT1 in response to the voltage of the first node Q1.

The second carry transistor MA2 may be connected between the first carry output terminal COUT1 and the third power input terminal VIN3, and a gate electrode of the second carry transistor MA2 may be connected to the second node QB1. The second carry transistor MA2 may control the electrical connection between the first carry output terminal COUT1 and the third power input terminal VIN3 in response to the voltage of the second node QB1.

Each of the first outputs 408a to 408k may be respectively connected to the scan clock input terminals SCINa to SCINk, respectively connected to the first output terminals OUT1a, OUT1b, . . . , and OUT1k, and connected to the fourth power input terminal VIN4. Each of the first outputs 408a to 408k may respectively include first output transistors MO1a, MO1b, . . . , and MO1k, and may respectively include second output transistors MO2a, MO2b, . . . , and MO2k.

A gate electrode of the first output transistors MO1a, MO1b, . . . , and MO1k may be respectively connected to the first local nodes Q1a to Q1k. A gate electrode of the second output transistors MO2a, MO2b, . . . , and MO2k may be electrically connected to the second node QB1.

In one or more embodiments, the first output 408a may electrically connect the first output terminal OUT1a to the scan clock input terminal SCINa or the fourth power input terminal VIN4 in response to voltages of the first local node Q1a and the second node QB1. The enable scan signal SC may be output when the scan clock signal SC_CKa is supplied to the first output terminal OUT1a. The enable scan signal SC supplied to the first output terminal OUT1a may be supplied to a scan line (e.g., SCL1) connected thereto. The first output 408a may include a first output transistor MO1a and a second output transistor MO2a.

The first output transistor MO1a may be connected between the scan clock input terminal SCINa and the first output terminal OUT1a. The gate electrode of the first output transistor MO1a may be connected to the first connector 412a via the first local node Q1a. The first output transistor MO1a may control an electrical connection between the scan clock input terminal SCINa and the first output terminal OUT1a in response to the voltage of the first local node Q1a.

The second output transistor MO2a may be connected between the first output terminal OUT1a and the fourth power input terminal VIN4, and a gate electrode of the second output transistor MO2a may be connected to the second node QB1. The second output transistor MO2a may control an electrical connection between the first output terminal OUT1a and the fourth power input terminal VIN4 in response to the voltage of the second node QB1.

In one or more embodiments, the first output 408b may electrically connect the first output terminal OUT1b to the scan clock input terminal SCINb or the fourth power input terminal VIN4 in response to voltages of the first local node Q1b and the second node QB1. The first output 408b may include a first output transistor MO1b and a second output transistor MO2b.

The first output transistor MO1b is connected between the scan clock input terminal SCINb and the first output terminal OUT1b. The gate electrode of the first output transistor MO1b may be connected to the first connector 412b via the first local node Q1b. The first output transistor MO1b may control an electrical connection between the scan clock input terminal SCINb and the first output terminal OUT1b in response to the voltage of the first local node Q1b.

The second output transistor MO2b may be connected between the first output terminal OUT1b and the fourth power input terminal VIN4, and a gate electrode of the second output transistor MO2b may be connected to the second node QB1. The second output transistor MO2b may control an electrical connection between the first output terminal OUT1b and the fourth power input terminal VIN4 in response to the voltage of the second node QB1.

In one or more embodiments, the first output 408k may electrically connect the first output terminal OUT1k to the scan clock input terminal SCINk or the fourth power input terminal VIN4 in response to voltages of the first local node Q1k and the second node QB1. The first output 408k may include a first output transistor MO1k and a second output transistor MO2k.

The first output transistor MO1k is connected between the scan clock input terminal SCINk and the first output terminal OUT1k. The gate electrode of the first output transistor MO1k may be connected to the first connector 412k via the first local node Q1k. The first output transistor MO1k may control an electrical connection between the scan clock input terminal SCINk and the first output terminal OUT1k in response to the voltage of the first local node Q1k.

The second output transistor MO2k may be connected between the first output terminal OUT1k and the fourth power input terminal VIN4, and a gate electrode of the second output transistor MO2k may be connected to the second node QB1. The second output transistor MO2k may control an electrical connection between the first output terminal OUT1k and the fourth power input terminal VIN4 in response to the voltage of the second node QB1.

Each of the first connectors 412a to 412k may be connected between the first node Q1 and a respective one of the first local nodes Q1a to Q1k. The first connectors 412a to 412k may control the electrical connection between the first node Q1 and the first local nodes Q1a to Q1k in response to the voltage of the first connection control line SCG1. Each of the first connectors 412a to 412k may include a respective one of switching transistors MSa, MSb, . . . , and MSk and a respective one of boosting capacitors Cba, Cbb, . . . , and Cbk.

Each of the switching transistors MSa to MSk may be connected between the first node Q1 and a respective one of the first local nodes Q1a to Q1k. A gate electrode of each of the switching transistors MSa to MSk may be connected to the first connection control line SCG1. The switching transistors MSa to MSk may control the electrical connection between the first node Q1 and the first local nodes Q1a to Q1k based on the voltage of the first connection control line SCG1.

Each of the boosting capacitors Cba to Cbk may be connected between a respective one of the first local nodes Q1a to Q1k and the first voltage control line VCG1. The boosting capacitors Cba to Cbk may control the voltages of the first local nodes Q1a to Q1k in response to the voltage of the first voltage control line VCG1.

The first controller 410 may control the voltage of the first connection control line SCG1 in response to the scan carry signals SCCRi−1 and SCCRi+1 input to the first scan carry input terminal SCIN1 and the second scan carry input terminal SCIN2. The first controller 410 may control the voltage of the first connection control line SCG1 in response to the initialization control signal INT_C input to the initialization terminal INTIN.

The first controller 410 may include a control transistor MC, a first control transistor MC1, a second control transistor MC2, and a third control transistor MC3.

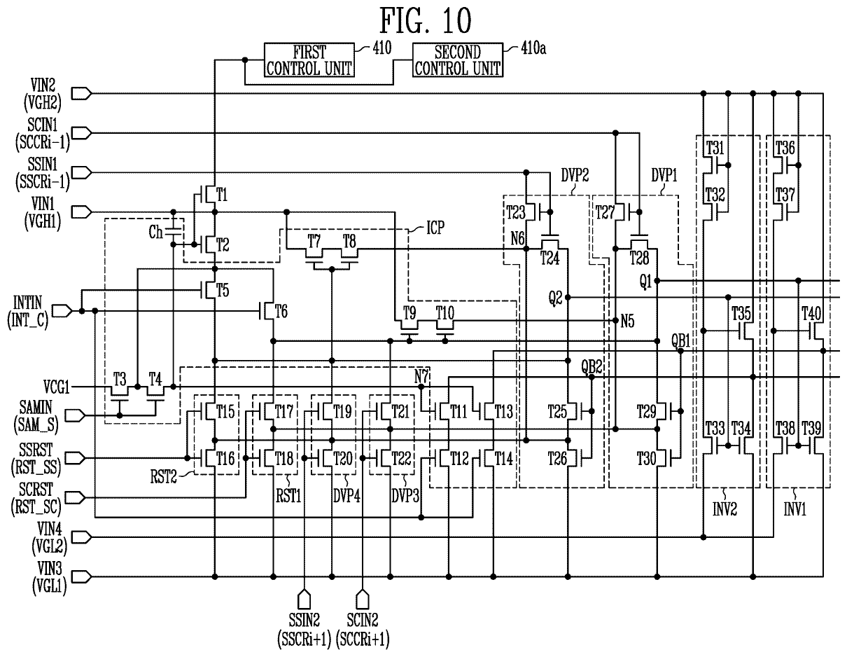

The control transistor MC may be connected between a first transistor T1 illustrated in FIG. 10 and the first connection control line SCG1, and a gate electrode of the control transistor MC may be connected to the initialization terminal INTIN. The control transistor MC may be turned on to electrically connect the first transistor T1 and the first connection control line SCG1 when the initialization control signal INT_C is input to the initialization terminal INTIN.

The first control transistor MC1 may be connected between the first power input terminal VIN1 and the first connection control line SCG1, and a gate electrode of the first control transistor MC1 may be connected to the first scan carry input terminal SCIN1. The first control transistor MC1 may be turned on to supply a voltage of the first power VGH1 to the first connection control line SCG1 when the scan carry signal SCCRi−1 (e.g., a first scan carry signal SCRi−1) of a previous stage is input to the first scan carry input terminal SCIN1. The first control transistor MC1 may consists of a plurality of transistors MC1a and MC1b connected in series so that leakage current is reduced.

The second control transistor MC2 may be connected between the second power input terminal VIN2 and the first connection control line SCG1, and a gate electrode of the second control transistor MC2 may be connected to the first voltage control line VCG1. The second control transistor MC2 may supply a voltage of the second power VGH2 to the first connection control line SCG1 while being turned on or off in response to the voltage of the first voltage control line VCG1.

The third control transistor MC3 may be connected between the second power input terminal VIN2 and the first connection control line SCG1, and a gate electrode of the third control transistor MC3 may be connected to the second scan carry input terminal SCIN2. The third control transistor MC3 may be turned on to supply a voltage of the second power VGH2 to the first connection control line SCG1 when the scan carry signal SCCRi+1 (e.g., a second scan carry signal SCRi+1) of a next stage is input to the second scan carry input terminal SCIN2.

The first reset 414 may control the electrical connection between the fifth power input terminal VIN5 and the first connection control line SCG1 in response to the voltage of the second node QB1. The first reset 414 may include a reset transistor MR.

The reset transistor MR may be connected between the fifth power input terminal VIN5 and the first connection control line SCG1, and a gate electrode of the reset transistor MR may be connected to the second node QB1. The reset transistor MR may control the electrical connection between the fifth power input terminal VIN5 and the first connection control line SCG1 in response to the voltage of the second node QB1. The reset transistor MR may include a plurality of transistors MRa and MRb connected in series.

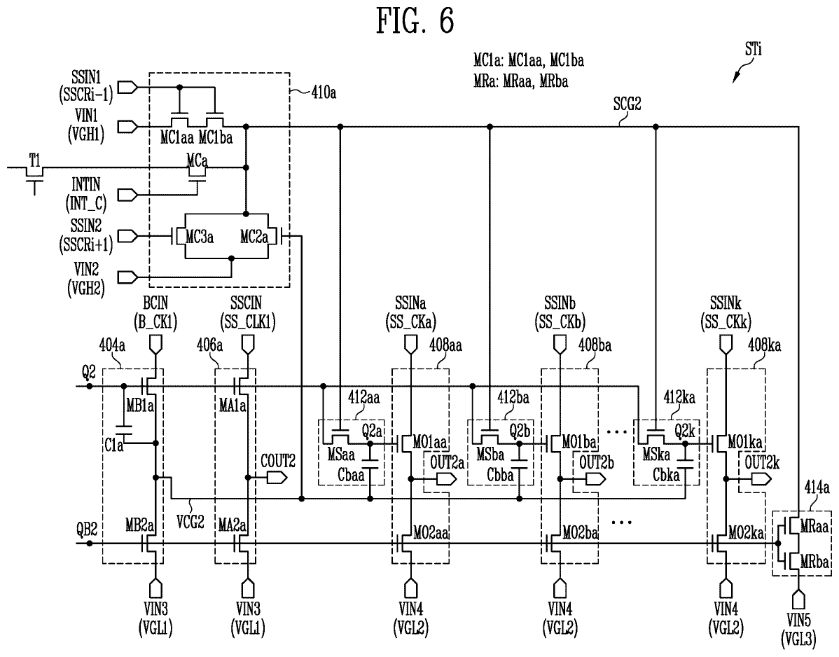

FIG. 6 is a diagram illustrating one or more embodiments of a second driving circuit illustrated in FIG. 4B.

Referring to FIG. 6, the second driving circuit may include a second controller 410a, a second booster 404a, a second carry output 406a, second outputs 408aa to 408ka, second connectors 412aa to 412ka, and a second reset 414a.

The second booster 404a may electrically connect the second voltage control line VCG2 to the boosting clock input terminal BCIN or the third power input terminal VIN3 in response to the voltages of the third node Q2 and the fourth node QB2. When the first boosting clock signal B_CK1 is supplied to the second voltage control line VCG2, the second boosting signal may be output. The second boosting signal supplied to the second voltage control line VCG2 may boost the voltages of the third node Q2 and the second local nodes Q2a, Q2b, . . . , and Q2k.

The second booster 404a may include a first boosting transistor MB1a, a second boosting transistor MB2a, and a first capacitor C1a.

The first boosting transistor MB1a may be connected between the boosting clock input terminal BCIN and the second voltage control line VCG2, and a gate electrode of the first boosting transistor MB1a may be connected to the third node Q2. The first boosting transistor MB1a may control the electrical connection between the boosting clock input terminal BCIN and the second voltage control line VCG2 based on the voltage of the third node Q2.

The second boosting transistor MB2a may be connected between the second voltage control line VCG2 and the third power input terminal VIN3, and a gate electrode of the second boosting transistor MB2a may be connected to the fourth node QB2. The second boosting transistor MB2a may control the electrical connection between the second voltage control line VCG2 and the third power input terminal VIN3 in response to the voltage of the fourth node QB2.

The second carry output 406a may electrically connect the second carry output terminal COUT2 to the initialization carry clock input terminal SSCIN or the third power input terminal VIN3 in response to voltages of the third node Q2 and the fourth node QB2. When the first initialization carry clock signal SS_CLK1 is output to the second carry output terminal COUT2, an initialization carry signal (e.g., an i-th initialization carry signals) may be output.

The second carry output 406a may include a first carry transistor MA1a and a second carry transistor MA2a.

The first carry transistor MA1a may be connected between the initialization carry clock input terminal SSCIN and the second carry output terminal COUT2, and a gate electrode of the first carry transistor MA1a may be connected to the third node Q2. The first carry transistor MA1a may control the electrical connection between the initialization carry clock input terminal SSCIN and the second carry output terminal COUT2 in response to the voltage of the third node Q2.

The second carry transistor MA2a may be connected between the second carry output terminal COUT2 and the third power input terminal VIN3, and a gate electrode of the second carry transistor MA2a may be connected to the fourth node QB2. The second carry transistor MA2a may control the electrical connection between the second carry output terminal COUT2 and the third power input terminal VIN3 in response to the voltage of the fourth node QB2.

Each of the second outputs 408aa to 408ka may be connected to a respective one of the initialization clock input terminals SSINa to SSINK, a respective one of the second output terminals OUT2a, OUT2b, . . . , and OUT2k, and the fourth power input terminal VIN4. Each of the second outputs 408aa to 408ka may include a respective one of first output transistors MO1aa, MO1ba, . . . , and MO1ka, and a respective one of second output transistors MO2aa, MO2ba, . . . , and MO2ka.

Gate electrodes of the first output transistors MO1aa, MO1ba, . . . , and MO1ka may be respectively connected to the second local nodes Q2a to Q2k. Gate electrodes of the second output transistors MO2aa, MO2ba, . . . , and MO2ka may be electrically connected to the fourth node QB2.

In one or more embodiments, the second output 408aa may electrically connect the second output terminal OUT2a to the initialization clock input terminal SSINa or the fourth power input terminal VIN4 in response to voltages of the second local node Q2a and the fourth node QB2. The enable initialization signal SS may be output when the initialization clock signal SS_CKa is supplied to the second output terminal OUT2a. The enable initialization signal SS supplied to the second output terminal OUT2a may be supplied to an initialization line (e.g., SNL1) connected thereto. The second output 408aa may include a first output transistor MO1aa and a second output transistor MO2aa.

The first output transistor MO1aa may be connected between the initialization clock input terminal SSINa and the second output terminal OUT2a. The gate electrode of the first output transistor MO1aa may be connected to the second connector 412aa via the second local node Q2a. The first output transistor MO1aa may control the electrical connection between the initialization clock input terminal SSINa and the second output terminal OUT2a in response to the voltage of the second local node Q2a.

The second output transistor MO2aa may be connected between the second output terminal OUT2a and the fourth power input terminal VIN4, and a gate electrode of the second output transistor MO2aa may be connected to the fourth node QB2. The second output transistor MO2aa may control the electrical connection between the second output terminal OUT2a and the fourth power input terminal VIN4 in response to the voltage of the fourth node QB2.

In one or more embodiments, the second output 408ba may electrically connect the second output terminal OUT2b to the initialization clock input terminal SSINb or the fourth power input terminal VIN4 in response to voltages of the second local node Q2b and the fourth node QB2. The second output 408ba may include a first output transistor MO1ba and a second output transistor MO2ba.

The first output transistor MO1ba may be connected between the initialization clock input terminal SSINb and the second output terminal OUT2b. The gate electrode of the first output transistor MO1ba may be connected to the second connector 412ba via the second local node Q2b. The first output transistor MO1ba may control the electrical connection between the initialization clock input terminal SSINb and the second output terminal OUT2b in response to the voltage of the second local node Q2b.

The second output transistor MO2ba may be connected between the second output terminal OUT2b and the fourth power input terminal VIN4, and a gate electrode of the second output transistor MO2ba may be connected to the fourth node QB2. The second output transistor MO2ba may control the electrical connection between the second output terminal OUT2b and the fourth power input terminal VIN4 in response to the voltage of the fourth node QB2.

In one or more embodiments, the second output 408ka may electrically connect the second output terminal OUT2k to the initialization clock input terminal SSINK or the fourth power input terminal VIN4 in response to voltages of the second local node Q2k and the fourth node QB2. The second output 408ka may include a first output transistor MO1ka and a second output transistor MO2ka.

The first output transistor MO1ka may be connected between the initialization clock input terminal SSINK and the second output terminal OUT2k. The gate electrode of the first output transistor MO1ka may be connected to the second connector 412ka via the second local node Q2k. The first output transistor MO1ka may control the electrical connection between the initialization clock input terminal SSINK and the second output terminal OUT2k in response to the voltage of the second local node Q2k.

The second output transistor MO2ka may be connected between the second output terminal OUT2k and the fourth power input terminal VIN4, and a gate electrode of the second output transistor MO2ka may be connected to the fourth node QB2. The second output transistor MO2ka may control the electrical connection between the second output terminal OUT2k and the fourth power input terminal VIN4 in response to the voltage of the fourth node QB2.

Each of the second connectors 412aa to 412ka may be connected between the third node Q2 and a respective one of the second local nodes Q2a to Q2k. The second connectors 412aa to 412ka may control the electrical connection between the third node Q2 and the second local nodes Q2a to Q2k in response to the voltage of the second connection control line SCG2. The second connectors 412aa to 412ka may each include a respective one of switching transistors MSaa, MSba, . . . , and MSka and a respective one of boosting capacitors Cbaa, Cbba, . . . , and Cbka.

Each of the switching transistors MSaa to MSka may be connected between the third node Q2 and a respective one of the second local nodes Q2a to Q2k. A gate electrode of each of the switching transistors MSaa to MSka may be connected to the second connection control line SCG2. The switching transistors MSaa to MSka may control the electrical connection between the third node Q2 and the second local nodes Q2a to Q2k based on the voltage of the second connection control line SCG2.

Each of the boosting capacitors Cbaa to Cbka may be connected between a respective one of the second local nodes Q2a to Q2k and the second voltage control line VCG2. The boosting capacitors Cbaa to Cbka may control the voltages of the second local nodes Q2a to Q2k in response to the voltage of the second voltage control line VCG2.

The second controller 410a may control the voltage of the second connection control line SCG2 in response to the initialization carry signals SSCRi−1 and SSCRi+1 input to the first initialization carry input terminal SSIN1 and the second initialization carry input terminal SSIN2. The second controller 410a may control the voltage of the second connection control line SCG2 in response to the initialization control signal INT_C input to the initialization terminal INTIN.

The second controller 410a may include a control transistor MCa, a first control transistor MC1a, a second control transistor MC2a, and a third control transistor MC3a.

The control transistor MCa may be connected between the first transistor T1 and the second connection control line SCG2, and a gate electrode of the control transistor MCa may be connected to the initialization terminal INTIN. The control transistor MCa may be turned on to electrically connect the first transistor T1 and the second connection control line SCG2 when the initialization control signal INT_C is input to the initialization terminal INTIN.

The first control transistor MC1a may be connected between the first power input terminal VIN1 and the second connection control line SCG2, and a gate electrode of the first control transistor MC1a may be connected to the first initialization carry input terminal SSIN1. The first control transistor MC1a may be turned on to supply the voltage of the first power VGH1 to the second connection control line SCG2 when the initialization carry signal SSCRi−1 (e.g., a first initialization carry signal SSCRi−1) of a previous stage is input to the first initialization carry input terminal SSIN1. The first control transistor MC1a may include a plurality of transistors MC1aa and MC1ba connected in series so that leakage current is reduced.

The second control transistor MC2a may be connected between the second power input terminal VIN2 and the second connection control line SCG2, and a gate electrode of the second control transistor MC2a may be connected to the second voltage control line VCG2. The second control transistor MC2a may supply a voltage of the second power VGH2 to the second connection control line SCG2 while being turned on or off in response to the voltage of the second voltage control line VCG2.

The third control transistor MC3a may be connected between the second power input terminal VIN2 and the second connection control line SCG2, and a gate electrode of the third control transistor MC3a may be connected to the second initialization carry input terminal SSIN2. The third control transistor MC3a may be turned on to supply the voltage of the second power VGH2 to the second connection control line SCG2 when the initialization carry signal SSCRi+1 (e.g., a second initialization carry signal SSCRi+1) of a next stage is input to the second initialization carry input terminal SSIN2.

The second reset 414a may control the electrical connection between the fifth power input terminal VIN5 and the second connection control line SCG2 in response to the voltage of the fourth node QB2. The second reset 414a may include a reset transistor MRa.

The reset transistor MRa may be connected between the fifth power input terminal VIN5 and the second connection control line SCG2, and a gate electrode of the reset transistor MRa may be connected to the fourth node QB2. The reset transistor MRa may control the electrical connection between the fifth power input terminal VIN5 and the second connection control line SCG2 in response to the voltage of the fourth node QB2. The reset transistor MRa may include a plurality of transistors MRaa and MRba connected in series.

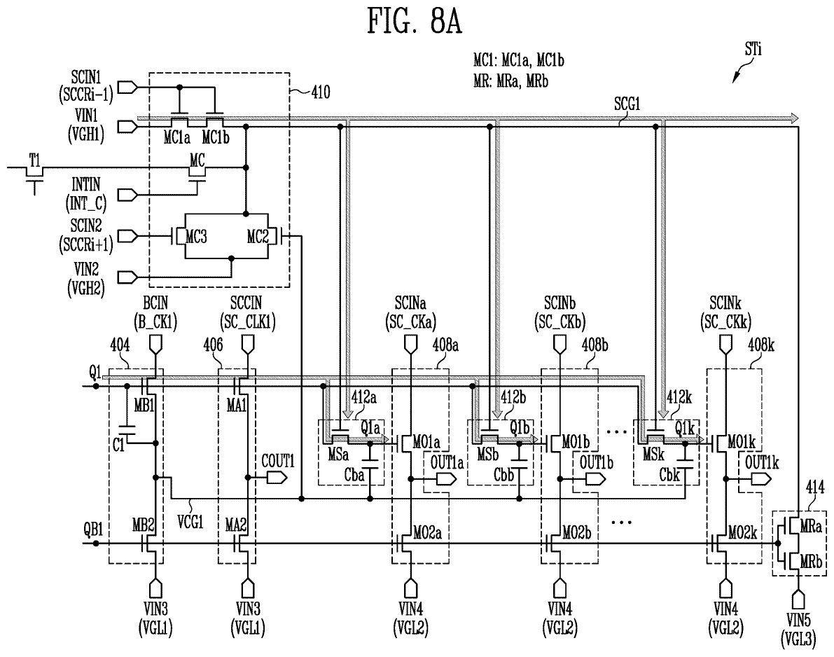

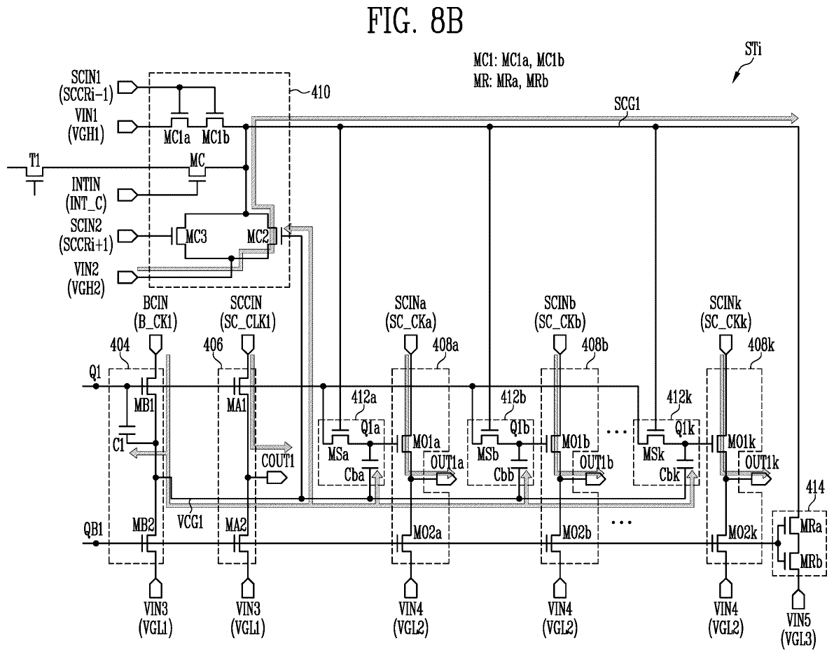

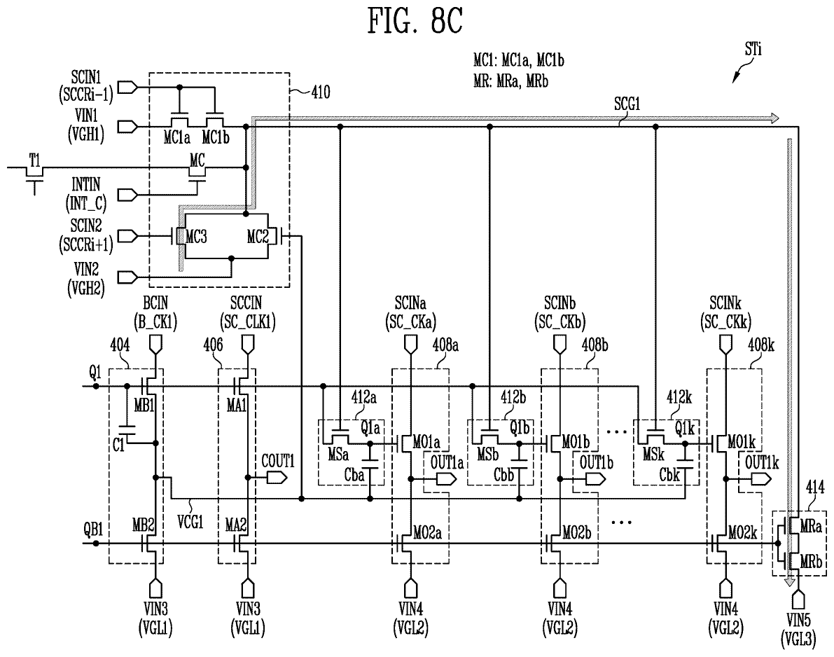

FIG. 7 is a waveform diagram illustrating one or more embodiments of a driving method of the first driving circuit illustrated in FIG. 5. FIGS. 8A to 8C are diagrams illustrating an operation process of the first driving circuit corresponding to the driving waveform of FIG. 7. A portion labeled SC_CKa-SC_CKk in FIG. 7 may represent scan clock signals SC_CKa to SC_CKk. Although some of the scan clock signals SC_CKa to SC_CKk are shown to overlap, the present disclosure is not limited thereto. For example, the scan clock signals SC_CKa to SC_CKk may be supplied so as not to overlap.

Referring to FIG. 7, the first scan carry clock signal SC_CLK1 and the second scan carry clock signal SC_CLK2 may have the same period or the same cycle and may have a phase difference of 180 degrees. The first boosting clock signal B_CK1 and the second boosting clock signal B_CK2 may have the same period and may have a phase difference of 180 degrees. The scan carry clock signals SC_CLK1 and SC_CLK2 and the boosting clock signals B_CK1 and B_CK2 may have the same period.

During one period or one cycle, a high voltage (e.g., a logic high level voltage) of the scan carry clock signals SC_CLK1 and SC_CLK2 may be supplied for a shorter amount of time than a low voltage (e.g., a logic low level voltage). During one period, a low voltage (e.g., a logic low level voltage) of the boosting clock signals B_CK1 and B_CK2 may be supplied for a shorter time than a high voltage (e.g., a logic high level voltage).

The low voltage of the first boosting clock signal B_CK1 may at least partially overlap the low voltage of the first scan carry clock signal SC_CLK1, and the high voltage of the first boosting clock signal B_CK1 may at least partially overlap the high voltage of the first scan carry clock signal SC_CLK1. The low voltage of the first boosting clock signal B_CK1 may at least partially overlap the high voltage of the second scan carry clock signal SC_CLK2, and the high voltage of the first boosting clock signal B_CK1 may at least partially overlap the low voltage of the second scan carry clock signal SC_CLK2.

The scan carry signal SCCR (SCCRi−1, SCCRi, SCCRi+1, SCCRi+2, . . . ) and may be set to a high voltage (e.g., a logic high level voltage) and may be synchronized with the high voltage of the scan carry clock signals SC_CLK1 and SC_CLK2. For example, the stage circuits may output a high voltage of the scan carry clock signals SC_CLK1 and SC_CLK2 to the scan carry signal SCCR (SCCRi−1, SCCRi, SCCRi+1, SCCRi+2, . . . ).

Referring to FIGS. 5, 7, and 8A, a first scan carry signal SCCRi−1 (e.g., a logic high level) may be input to the first scan carry input terminal SCIN1 during a first period T1. When the first scan carry signal SCCRi−1 is input to the first scan carry input terminal SCIN1, the driver 402 may supply a voltage (for example, a high voltage) of the first power VGH1 to the first node Q1, and may supply a voltage (e.g., a low voltage) of the third power VGL1 to the second node QB1. A detailed operation process with respect to the driver 402 will be described later.

When a high voltage is supplied to the first node Q1, the first boosting transistor MB1 and the first carry transistor MA1 may be turned on. When the first boosting transistor MB1 is turned on, the boosting clock input terminal BCIN may be electrically connected to the first voltage control line VCG1. When the first carry transistor MA1 is turned on, the scan carry clock input terminal SCCIN may be electrically connected to the first carry output terminal COUT1.

When the first scan carry signal SCCRi−1 is input to the first scan carry input terminal SCIN1, the first control transistor MC1 may be turned on. When the first control transistor MC1 is turned on, a voltage of the first power VGH1 may be supplied to the first connection control line SCG1. When a high voltage (e.g., a voltage of the first power VGH1) is supplied to the first connection control line SCG1, the switching transistors MSa to MSk may be turned on. When the switching transistors MSa to MSK are turned on, a high voltage of the first node Q1 may be supplied to the first local nodes Q1a to Q1k. When a high voltage is supplied to the first local nodes Q1a to Q1k, the first output transistors MO1a, MO1b, . . . , and MO1k may be turned on.

Referring to FIGS. 5, 7, and 8B, the first scan carry clock signal SC_CLK1 of a high level may be input to the scan carry clock input terminal SCCIN during a second period T2. The first scan carry clock signal SC_CLK1 of a high level input to the scan carry clock input terminal SCCIN may be supplied to the first carry output terminal COUT1 via the first carry transistor MA1. The first scan carry clock signal SC_CLK1 of a high level output to the first carry output terminal COUT1 may be supplied to the next stage circuit and/or the previous stage circuit as an i-th scan carry signal SSCRi.

A first boosting clock signal B_CK1 of a high level may be input to the boosting clock input terminal BCIN during the second period T2. The first boosting clock signal B_CK1 of a high level may be supplied as a first boosting signal to the first voltage control line VCG1 via the first boosting transistor MB1. Accordingly, the first voltage control line VCG1 may be raised from a low voltage to a high voltage by the first boosting signal.

When the voltage of the first voltage control line VCG1 is increased by the first boosting signal, the voltage of the second node Q1 may be increased by the first capacitor C1. For example, the voltage of the first node Q1 may be increased to a voltage that is approximately twice as high as that of the first power VGH1.

When the voltage of the first voltage control line VCG1 is increased by the first boosting signal, the voltages of the first local nodes Q1a to Q1k may be increased by the boosting capacitors Cba to Cbk. For example, the first local nodes Q1a to Q1k may be raised to a voltage that is approximately twice as high as that of the first power VGH1. When the voltage of the first local nodes Q1a to Q1k is raised to a voltage higher than the first power VGH1, the first output transistors MO1a, MO1b, . . . , and MO1k may stably remain turned on during the second period T2.

When the voltage of the first voltage control line VCG1 is increased by the first boosting signal, the second control transistor MC2 may be turned on. When the second control transistor MC2 is turned on, a voltage of the second power VGH2 may be supplied to the first connection control line SCG1. The voltage of the second power VGH2 supplied to the first connection control line SCG1 may be supplied to gate electrodes of the switching transistors MSa to MSk.

In this case, the first electrode and the second electrode of each of the switching transistors MSa to MSk are set to a voltage higher than that of the first power VGH1. Accordingly, when a voltage of the second power VGH2 lower than the first power VGH1 is supplied to the gate electrodes of the switching transistors MSa to MSk, the switching transistors MSA to MSk may be turned off.

The scan clock signals SC_CKa to SC_CKk of a high level may be respectively input to the scan clock input terminals SCINa to SCINk during the second period T2. In this case, because the first output transistors MO1a to MO1k maintain a turn-on state, the scan clock signals SC_CKa to SC_CKk of a high level may be supplied to the first output terminals OUT1a to OUT1k as the enable scan signal SC.

During the second period T2 in which the enable scan signal SC is output to the first output terminals OUT1a to OUT1k, the switching transistors MSa to MSk may maintain a turn-off state, thereby displaying an image of uniform luminance in the pixel 110.

In other words, if the switching transistors MSa to MSk are not provided, the voltage of the first node Q1 and the first local nodes Q1a to Q1k may be changed by a parasitic capacitor of the first output transistors MO1a to MO1k during the second period T2 in which the enable scan signal SC is output. For example, the first node Q1 (and the first local nodes Q1a to Q1k) may have different voltages corresponding to a supply order of the enable scan signal SC, and thus a luminance difference may be generated in units of horizontal lines.

On the other hand, as in embodiments of the present disclosure, when the first local nodes Q1a to Q1k and the first node Q1 are electrically blocked by the switching transistors MSa to MSk during a period in which the enable scan signal SC is output, the first node Q2 may maintain a constant voltage. Then, the first local nodes Q1a to Q1k may have substantially the same voltage changed by the output of the enable scan signal SC, thereby reducing or preventing a luminance difference from occurring in units of horizontal lines.

In one or more embodiments of the present disclosure, during the second period T2, the switching transistors MSa to MSk may be turned off using a voltage of the second power VGH2 that is a positive voltage. In this case, a Vgs voltage difference between the switching transistors MSa to MSk may be kept low, thereby reducing or minimizing stress of the switching transistors MSA to MSk to ensure driving stability.

Referring to FIGS. 5, 7, and 8C, a second scan carry signal SCCRi+1 may be input to the second scan carry input terminal SCIN2 after the second period T2. When the second scan carry signal SCCRi+1 is input to the second scan carry input terminal SCIN2, a voltage of the third power VGL1 (or a low voltage) may be supplied to the first node Q1, and a voltage of the second power VGH2 (or a high voltage) may be provided to the second node QB1. The second node QB1 may be raised to a high voltage by an inverter included in the driver 402, and in this case, the second node QB2 may gradually raise to the high voltage by a load of circuit elements connected to the second node QB1.

When the second scan carry signal SCCRi+1 is input to the second scan carry input terminal SCIN2, the third control transistor MC3 may be turned on. When the third control transistor MC3 is turned on, a voltage of the second power VGH2 may be supplied to the first connection control line SCG1. In this case, because the first node Q1 is set to a voltage of the third power VGL1, the switching transistors MSa to MSk may be turned on. When the switching transistors MSa to MSk are turned on, the first local nodes Q1a to Q1k may have a low voltage.

Because the voltage of the second node QB1 gradually rises to a high voltage, after the first local nodes Q1a to Q1k are set to a low voltage, the reset transistor MR may be turned on. When the reset transistor MR is turned on, a voltage of the fifth power VGL3 may be supplied to the first connection control line SCG1.

The second node QB1 may maintain the high voltage for at least a partial period excluding the first period T1 and the second period T2, and thus the first connection control line SCG1 may maintain the voltage of the fifth power VGL3. When the fifth power VGL3 is supplied to the first connection control line SCG1, the switching transistors MSa to MSk are turned off, and thus the first local nodes Q1a to Q1k may maintain a low voltage.

The stage circuit STi according to the above-described embodiments of the present disclosure may be driven by receiving the first scan carry signal SCCRi−1 as a carry signal of the previous stage and the second scan carry signal SCRi+1 as a carry signal of the next stage. When the scan carry signal of the next stage is an (i+1)-th scan carry signal SCCRi+1, addition of an unnecessary dummy stage may be reduced or minimized.

For example, when an (i+2)-th scan carry signal or more scan carry signals are used as the scan carry signal of the next stage, dummy stages should be further provided. In addition, when the (i+2)-th carry signal is used as the scan carry signal of the next stage, it may be difficult to secure the sensing period.

FIG. 9 is a waveform diagram illustrating one or more embodiments of a driving method of the second driving circuit illustrated in FIG. 6. A portion labeled SS_CKa-SS_CKk in FIG. 9 may represent initialization clock signals SS_CKa to SS_CKk. Although some of the initialization clock signals SS_CKa to SS_CKk are shown to overlap, the present disclosure is not limited thereto. For example, the initialization clock signals SS_CKa to SS_CKk may be supplied so as not to overlap. The driving method of the second driving circuit illustrated in FIG. 9 is substantially the same as the driving method of the first driving circuit shown in FIG. 7, and thus will be briefly described.

Referring to FIG. 9, the first initialization carry clock signal SS_CLK1 and the second initialization carry clock signal SS_CLK2 have the same period and may have a phase difference of 180 degrees.

The initialization carry signal SSCR (SSCRi−1, SSCRi, SSCRi+1, SSCRi+2, . . . ) and may be set to a high voltage (e.g., a logic high level voltage) and may be synchronized with a high voltage of the initialization carry clock signals SS_CLK1 and SS_CLK2. For example, the stage circuits may output a high voltage of the initialization carry clock signals SS_CLK1 and SS_CLK2 to the initialization carry signal SSCR (SSCRi−1, SSCRi, SSCRi+1, SSCRi+2, . . . ).

Referring to FIGS. 6 and 9, a first initialization carry signal SCCRi−1 (e.g., a logic high level) may be input to the first initialization carry input terminal SSIN1 during a first period T1a. When the first initialization carry signal SSCRi−1 is input to the first initialization carry input terminal SSIN1, the driver 402 may supply a voltage (e.g., a high voltage) of the first power VGH1 to the third node Q2, and a voltage (e.g., a low voltage) of the third power VGL1 to the fourth node QB2.

When a high voltage is supplied to the third node Q2, the first boosting transistor MB1a and the first carry transistor MA1a may be turned on. When the first boosting transistor MB1a is turned on, the boosting clock input terminal BCIN may be electrically connected to the second voltage control line VCG2. When the first carry transistor MA1a is turned on, the initialization carry clock input terminal SSCIN may be electrically connected to the second carry output terminal COUT2.

When the first initialization carry signal SSCRi−1 is input to the first initialization carry input terminal SSIN1, the first control transistor MC1a may be turned on. When the first control transistor MC1a is turned on, a voltage of the first power VGH1 may be supplied to the second connection control line SCG2. The switching transistors MSaa to MSka may be turned on when a high voltage (e.g., a voltage of the first power VGH1) is supplied to the second connection control line SCG2. When the switching transistors MSaa to MSka are turned on, a high voltage of the third node Q2 may be supplied to the second local nodes Q2a to Q2k. When a high voltage is supplied to the second local nodes Q2a to Q2k, the first output transistors MO1aa to MO1ka may be turned on.

During the second period T2a, the first initialization carry clock signal SS_CLK1 of a high voltage may be input to the initialization carry clock input terminal SSCIN. The first initialization carry clock signal SS_CLK1 of a high voltage input to the initializing carry clock input terminal SSCIN may be supplied to the second carry output terminal OUT2 via the first carry transistor MA1a. The first initialization carry clock signal SS_CLK1 of a high voltage output to the second carry output terminal OUT2 may be supplied to the next stage circuit and/or the previous stage circuit as the i-th initialization carry signal SCCRi.

A first boosting clock signal B_CK1 of a high level may be input to the boosting clock input terminal BCIN during the second period T2a. The first boosting clock signal B_CK1 of a high level may be supplied as a second boosting signal to the second voltage control line VCG2 via the first boosting transistor MB1a. Accordingly, the second voltage control line VCG2 may be raised from the low voltage to the high voltage by the second boosting signal.

When the voltage of the second voltage control line VCG2 is increased by the second boosting signal, the voltage of the third node Q2 may be increased by the first capacitor C1a. For example, the voltage of the third node Q2 may be increased to a voltage that is approximately twice as high as that of the first power VGH1.

When the voltage of the second voltage control line VCG2 is increased by the second boosting signal, the voltages of the second local nodes Q2a to Q2k may be increased by the boosting capacitors Cbaa to Cbka. For example, the second local nodes Q2a to Q2k may be raised to a voltage that is approximately twice as high as that of the first power VGH1. When the voltage of the second local nodes Q2a to Q2k is raised to a voltage higher than the first power VGH1, the first output transistors MO1aa, MO1ba, . . . , and MO1ka may be stably maintained in a turn-on state during the second period T2.

When the voltage of the second voltage control line VCG2 is increased by the second boosting signal, the second control transistor MC2a may be turned on. When the second control transistor MC2a is turned on, a voltage of the second power VGH2 may be supplied to the second connection control line SCG2. The voltage of the second power VGH2 supplied to the second connection control line SCG2 may be supplied to gate electrodes of the switching transistors MSaa to MSka.

In this case, the first electrode and the second electrode of each of the switching transistors MSaa to MSka are set to a voltage higher than that of the first power VGH1. Accordingly, when a voltage of the second power VGH2 lower than the first power VGH1 is supplied to the gate electrodes of the switching transistors MSaa to MSka, the switching transistors MSaa to MSka may be turned off.

The initialization clock signals SS_CKa to SS_CKk of a high level may be input to the initialization clock input terminals SSINa to SSINK during the second period T2a. In this case, because the first output transistors MO1aa to MO1ka maintain a turn-on state, the initialization clock signals SS_CKa to SS_CKk of a high level may be supplied to the second output terminals OUT2a to OUT2k as the enable initialization signal SS.

During the second period T2 in which the enable initialization signal SS is output to the second output terminals OUT2a to OUT2k, the switching transistors MSaa to MSka may maintain a turn-off state, thereby displaying an image of uniform luminance in the pixel 110.

A second initialization carry signal SSCRi+1 may be input to the second initialization carry input terminal SSIN2 after the second period T2a. When the second initialization carry signal SSCRi+1 is input, a voltage of the third power VGL1 (or a low voltage) may be supplied to the third node Q2, and a voltage of the second power VGH2 (or a high voltage) may be provided to the fourth node QB2. The fourth node QB2 may be raised to a high voltage by an inverter included in the driver 402, and in this case, the fourth node QB2 may gradually raise to a high voltage by a load of circuit elements connected to the fourth node QB2.

When the second initialization carry signal SSCRi+1 is input to the second initialization carry input terminal SSIN2, the third control transistor MC3a may be turned on. When the third control transistor MC3a is turned on, a voltage of the second power VGH2 may be supplied to the second connection control line SCG2. In this case, the switching transistors MSaa to MSka may be turned on because the third node Q2 is set to a voltage of the third power VGL1. When the switching transistors MSaa to MSka are turned on, the second local nodes Q2a to Q2k may have a low voltage.

Because the voltage of the fourth node QB2 gradually rises to a high voltage, after the second local nodes Q2a to Q2k are set to a low voltage, the reset transistor MRa may be turned on. When the reset transistor MRa is turned on, a voltage of the fifth power VGL3 may be supplied to the second connection control line SCG2.

The fourth node QB2 may maintain the high voltage for at least a partial period excluding the first period T1 and the second period T2, and thus the second connection control line SCG2 may maintain the voltage of the fifth power VGL3. When the fifth power VGL3 is supplied to the second connection control line SCG2, the switching transistors MSaa to MSka are turned off, and thus the second local nodes Q2a to Q2k may maintain a low voltage.

FIG. 10 is a diagram illustrating one or more embodiments of the driver illustrated in FIG. 4A.

Referring to FIG. 10, a driver 402 according to one or more embodiments of the present disclosure may include an initialization controller ICP, a first reset RST1, a second reset RST2, a first driver DVP1, a second driver DVP2, a third driver DVP3, a fourth driver DVP4, a first inverter (e.g., first inverter unit) INV1, and a second inverter (e.g., second inverter unit) INV2. A first transistor T1 and a second transistor T2 may be provided so as not to be included in the driver 402.

The first inverter INV1 may control a voltage of the second node QB1 in response to a voltage of the first node Q1. For example, when the voltage of the first node Q1 is a high voltage (or a low voltage), the first inverter INV1 may set the voltage of the second node QB1 to a low voltage (or a high voltage).

The first inverter INV1 may include a thirty-sixth transistor T36, a thirty-seventh transistor T37, a thirty-eighth transistor T38, a thirty-ninth transistor T39, and a fortieth transistor T40.

The thirty-sixth transistor T36 and the thirty-seventh transistor T37 may be connected in series between the second power input terminal VIN2 and a gate electrode of the fortieth transistor T40. Gate electrodes of the thirty-sixth transistor T36 and the thirty-seventh transistor T37 may be connected to the second power input terminal VIN2. The thirty-sixth transistor T36 and the thirty-seventh transistor T37 may be diode-connected so that a current may flow from the second power input terminal VIN2 to the gate electrode of the fortieth transistor T40.

The thirty-eighth transistor T38 may be connected between the gate electrode of the fortieth transistor T40 and the fourth power input terminal VIN4. A gate electrode of the thirty-eighth transistor T38 may be connected to the first node Q1.

The thirty-ninth transistor T39 may be connected between the second node QB1 and the third power input terminal VIN3. A gate electrode of the thirty-ninth transistor T39 may be connected to the first node Q1.

The fortieth transistor T40 may be connected between the second power input terminal VIN2 and the second node QB1. The gate electrode of the fortieth transistor T40 may be connected to a common node between the thirty-seventh transistor T37 and the thirty-eighth transistor T38 (or a common terminal of the thirty-seventh and thirty-eighth transistors T37 and T38).

The second inverter INV2 may control the voltage of the fourth node QB2 in response to the voltage of the third node Q2. For example, when the voltage of the third node Q2 is a high voltage (or a low voltage), the second inverter INV2 may set the voltage of the fourth node QB2 to a low voltage (or a high voltage).

The second inverter INV2 may include a thirty-first transistor T31, a thirty-second transistor T32, a thirty-third transistor T33, a thirty-fourth transistor T34, and a thirty-fifth transistor T35.

The thirty-first transistor T31 and the thirty-second transistor T32 may be connected in series between the second power input terminal VIN2 and a gate electrode of the thirty-fifth transistor T35. Gate electrodes of the thirty-first transistor T31 and the thirty-second transistor T32 may be connected to the second power input terminal VIN2. The thirty-first transistor T31 and the thirty-second transistor T32 may be diode-connected so that a current may flow from the second power input terminal VIN2 to the gate electrode of the thirty-fifth transistor T35.

The thirty-third transistor T33 may be connected between the gate electrode of the thirty-fifth transistor T35 and the fourth power input terminal VIN4. The gate electrode of the thirty-third transistor T33 may be connected to the third node Q2.

The thirty-fourth transistor T34 may be connected between the fourth node QB2 and the third power input terminal VIN3. A gate electrode of the thirty-fourth transistor T34 may be connected to the third node Q2.

The thirty-fifth transistor 35 may be connected between the second power input terminal VIN2 and the fourth node QB2. A gate electrode of the thirty-fifth transistor 35 may be connected to a common node between the thirty-second transistor T32 and the thirty-third transistor T33 (or a common terminal of the thirty-second and thirty-third transistors T32 and T33).

The first driver DVP1 may supply a high voltage to the first node Q1 when the first scan carry signal SCCRi−1 is input from the first scan carry input terminal SCIN1. The first driver DVP1 may include a twenty-seventh transistor T27, a twenty-eighth transistor T28, a twenty-ninth transistor T29, and a thirtieth transistor T30.

The twenty-seventh transistor T27 may be connected between the first scan carry input terminal SCIN1 and a fifth node N5. A gate electrode of the twenty-seventh transistor T27 may be connected to the first scan carry input terminal SCIN1. The twenty-seventh transistor T27 may be diode-connected so that a current may flow from the first scan carry input terminal SCIN1 to the fifth node N5.

The twenty-eighth transistor T28 may be connected between the fifth node N5 and the first node Q1. A gate electrode of the twenty-eighth transistor T28 may be connected to the first scan carry input terminal SCIN1.

The twenty-ninth transistor T29 may be connected between the first node Q1 and the fifth node N5. A gate electrode of the twenty-ninth transistor T29 may be connected to the second node QB1.

The thirtieth transistor T30 may be connected between the fifth node N5 and the third power input terminal VIN3. A gate electrode of the thirtieth transistor T30 may be connected to the second node QB1.

The second driver DVP2 may supply a high voltage to the third node Q2 when the first initialization carry signal SSCRi−1 is input from the first initialization carry input terminal SSIN1. The second driver DVP2 may include a twenty-third transistor T23, a twenty-fourth transistor T24, a twenty-fifth transistor T25, and a twenty-sixth transistor T26.

The twenty-third transistor T23 may be connected between the first initialization carry input terminal SSIN1 and a sixth node N6. A gate electrode of the twenty-third transistor T23 may be connected to the first initialization carry input terminal SSIN1. The twenty-third transistor T23 may be diode-connected so that a current may flow from the first initialization carry input terminal SSIN1 to the sixth node N6.

The twenty-fourth transistor T24 may be connected between the sixth node N6 and the third node Q2. A gate electrode of the twenty-fourth transistor T24 may be connected to the first initialization carry input terminal SSIN1.

The twenty-fifth transistor T25 may be connected between the third node Q2 and the sixth node N6. A gate electrode of the twenty-fifth transistor T25 may be connected to the fourth node QB2.

The twenty-sixth transistor T26 may be connected between the sixth node N6 and the third power input terminal VIN3. A gate electrode of the twenty-sixth transistor T26 may be connected to the fourth node QB2.

The third driver DVP3 may control the voltage of the first node Q1 based on the second scan carry signal SCCRi+1 input to the second scan carry input terminal SCIN2. The third driver DVP3 may include a twenty-first transistor T21 and a twenty-second transistor T22.

The twenty-first transistor T21 may be connected between the first node Q1 and the fifth node N5. A gate electrode of the twenty-first transistor T21 may be connected to the second scan carry input terminal SCIN2.

The twenty-second transistor T22 may be connected between the fifth node N5 and the third power input terminal VIN3. A gate electrode of the twenty-second transistor T22 may be connected to the second scan carry input terminal SCIN2.

The fourth driver DVP4 may control the voltage of the third node Q2 based on the second initialization carry signal SSCRi+1 input to the second initialization carry input terminal SSIN2. The fourth driver DVP4 may include a nineteenth transistor T19 and a twentieth transistor T20.

The nineteenth transistor T19 may be connected between the third node Q2 and the sixth node N6. A gate electrode of the nineteenth transistor T19 may be connected to the second initialization carry input terminal SSIN2.

The twentieth transistor T20 may be connected between the sixth node N6 and the third power input terminal VIN3. A gate electrode of the twentieth transistor T20 may be connected to the second initialization carry input terminal SSIN2.

The first reset RST1 may control the voltage of the first node Q1 based on the scan reset signal RST_SC input to the scan reset input terminal SCRST. The first reset RST1 may include a seventeenth transistor T17 and an eighteenth transistor T18.

The seventeenth transistor T17 may be connected between the first node Q1 and the fifth node N5. A gate electrode of the seventeenth transistor T17 may be connected to the scan reset input terminal SCRST.

The eighteenth transistor T18 may be connected between the fifth node N5 and the third power input terminal VIN3. A gate electrode of the eighteenth transistor T18 may be connected to the scan reset input terminal SCRST.

The seventeenth transistor T17 and the eighteenth transistor T18 may be turned on when the scan reset signal RST_SC is input to supply the voltage of the third power VGL1 to the first node Q1. The scan reset signal RST_SC is supplied to initialize the stage circuit, and may be supplied, for example, after the display device is turned on.

The second reset RST2 may control the voltage of the third node Q2 based on the initialization reset signal RST_SS input to the initialization reset input terminal SSRST. The second reset RST2 may include a fifteenth transistor T15 and a sixteenth transistor T16.

The fifteenth transistor T15 may be connected between the third node Q2 and the sixth node N6. A gate electrode of the fifteenth transistor T15 may be connected to the initialization reset input terminal SSRST.

The sixteenth transistor T16 may be connected between the sixth node N6 and the third power input terminal VIN3. A gate electrode of the sixteenth transistor T16 may be connected to the initialization reset input terminal SSRST.

The fifteenth transistor T15 and the sixteenth transistor T16 may be turned on when the initialization reset signal RST_SS is input to supply the voltage of the third power VGL1 to the third node Q2. The initialization reset signal RST_SS is supplied to initialize the stage circuit, and may be supplied, for example, after the display device is turned on.

The initialization controller ICP may supply an enable scan signal SC to a scan line located on a corresponding horizontal line and an enable initialization signal SS to an initialization line located on the corresponding horizontal line during a sensing period based on a sampling signal SAM_S input to the sampling input terminal SAMIN and an initialization control signal INT_C input to the initialization terminal INTIN. The initialization controller ICP may include a third transistor T3, a fourth transistor T4, a fifth transistor T5, a sixth transistor T6, a seventh transistor T7, an eighth transistor T8, a ninth transistor T9, a tenth transistor T10, an eleventh transistor T11, a twelfth transistor T12, a thirteenth transistor T13, and a fourteenth transistor T14.

The third transistor T3 and the fourth transistor T4 may be connected in series between the first voltage control line VCG1 and a seventh node N7. Gate electrodes of the third transistor T3 and the fourth transistor T4 may be connected to the sampling input terminal SAMIN.

The fifth transistor T5 may be connected between the second transistor T2 and the third node Q2. A gate electrode of the fifth transistor T5 may be connected to the initialization terminal INTIN.

The sixth transistor T6 may be connected between the second transistor T2 and the first node Q1. A gate electrode of the sixth transistor T6 may be connected to the initialization terminal INTIN.

The seventh transistor T7 and the eighth transistor T8 may be connected between the first power input terminal VIN1 and the sixth node N6. Gate electrodes of the seventh transistor T7 and the eighth transistor T8 may be connected to the third node Q2.

The ninth transistor T9 and the tenth transistor T10 may be connected between the first power input terminal VIN1 and the fifth node N5. Gate electrodes of the ninth transistor T9 and the tenth transistor T10 may be connected to the first node Q1.

The eleventh transistor T11 and the twelfth transistor T12 may be connected between the fourth node QB2 and the third power input terminal VIN3. A gate electrode of the eleventh transistor T11 may be connected to the seventh node N7, and a gate electrode of the twelfth transistor T12 may be connected to an initialization terminal INTIN.

The thirteenth transistor T13 and the fourteenth transistor T14 may be connected between the second node QB1 and the third power input terminal VIN3. A gate electrode of the thirteenth transistor T13 may be connected to the seventh node N7, and a gate electrode of the fourteenth transistor T14 may be connected to an initialization terminal INTIN.

A first electrode of the first transistor T1 may be connected to the first controller 410 and the second controller 410a, and a second electrode of the first transistor T1 may be connected to the first power input terminal VIN1. For example, the first electrode of the first transistor T1 may be connected to the control transistors MC and MCa illustrated in FIGS. 5 and 6. A gate electrode of the first transistor T1 may be connected to a second electrode of a holding capacitor Ch. The first transistor T1 may be turned on or off corresponding to a voltage of the holding capacitor Ch.

A first electrode of the second transistor T2 may be connected to the first power input terminal VIN1, and a second electrode of the second transistor T2 may be connected to the initialization controller ICP (for example, a common node of the third transistor T3 and the fourth transistor T4) (or the driver 402). A gate electrode of the second transistor T2 may be connected to the second electrode of the holding capacitor Ch. The second transistor T2 may be turned on or off corresponding to the voltage of the holding capacitor Ch.

In one or more embodiments of the present disclosure, a configuration of the driver 402 except for the first transistor T1 and the second transistor T2 may be set to various currently known circuits. For example, the driver 402 may be configured with various currently known circuits capable of controlling the first node Q1, the second node QB1, the third node Q2, and the fourth node QB2.

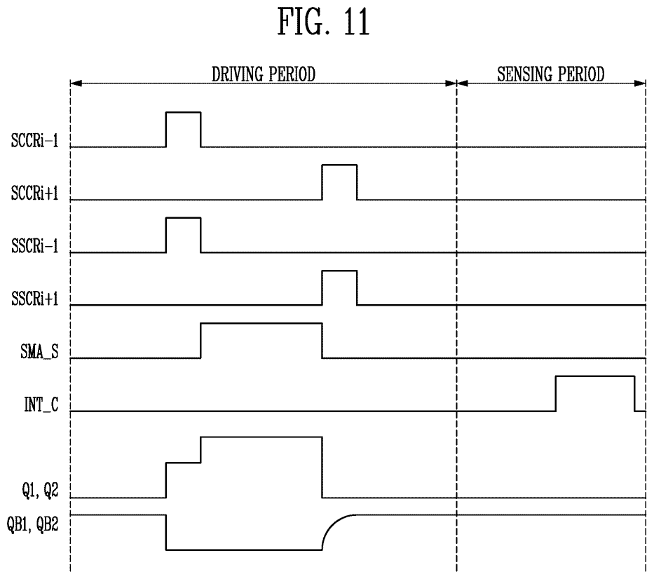

FIG. 11 is a waveform diagram illustrating an operation process of the driver illustrated in FIG. 10. In describing FIG. 11, portions described with reference to FIGS. 7 and 9 will be omitted or briefly described.

Referring to FIG. 11, the first scan carry signal SCCRi−1 may be input to the first scan carry input terminal SCIN1 and the first initialization carry signal SSCRi−1 may also be input to the second initialization carry input terminal SSIN1 during the driving period.

When the first scan carry signal SCCRi−1 is input, the twenty-seventh transistor T27 and the twenty-eighth transistor T28 are turned on, and thus the first node Q1 may be raised to a high voltage. When the first node Q1 is raised to a high voltage, the ninth transistor T9 and the tenth transistor T10 may be turned on, and the voltage of the first power VGH1 may be supplied to the fifth node N5. The fifth node N5 may be electrically connected to the first node Q1 via the twenty-eighth transistor T28, so that the first node Q1 may have approximately the voltage of the first power VGH1.

When the first node Q1 has a high voltage, the thirty-eighth transistor T38 and the thirty-ninth transistor T39 may be turned on. When the thirty-eighth transistor T38 is turned on, the voltage of the fourth power VGL2 is supplied to the gate electrode of the fortieth transistor T40, and thus the fortieth transistor T40 is turned off. When the thirty-ninth transistor T39 is turned on, a voltage of the third power VGL1 may be supplied to the second node QB1, and thus the second node QB1 may have a low voltage.

When the first initialization carry signal SSCRi−1 is input, the twenty-third transistor T23 and the twenty-fourth transistor T24 are turned on, and thus the third node Q2 may be raised to a high voltage. When the third node Q2 is raised to a high voltage, the seventh transistor T7 and the eighth transistor T8 may be turned on, and the voltage of the first power VGH1 may be supplied to the sixth node N6. The sixth node N6 may be electrically connected to the third node Q2 via the twenty-fourth transistor T24, so that the third node Q2 may have a voltage of the first power VGH1.

When the third node Q2 has a high voltage, the thirty-third transistor T33 and the thirty-fourth transistor T34 may be turned on. When the thirty-third transistor T33 is turned on, the voltage of the fourth power VGL2 may be supplied to the gate electrode of the thirty-fifth transistor T35, and thus the thirty-fifth transistor T35 may be turned off. When the thirty-fourth transistor T34 is turned on, a voltage of the third power VGL1 may be supplied to the fourth node QB2, and thus the fourth node QB2 may have a low voltage.

The sampling signal SAM_S may be input to the sampling input terminal SAMIN during the driving period. For example, the sampling signal SAM_S may be supplied during a period in which the enable scan signal SC and the enable initialization signal SS are output at a corresponding stage circuit. When the sampling signal SAM_S is supplied, the third transistor T3 and the fourth transistor T4 included in the corresponding stage circuit may be turned on.

When the third transistor T3 and the fourth transistor T4 are turned on, the first voltage control line VCG1 may be electrically connected to the second electrode of the holding capacitor Ch. Then, a voltage corresponding to the first boosting signal supplied to the first voltage control line VCG1 (for example, a voltage corresponding to the turn-on of the third transistor T3 and the fourth transistor T4) may be stored in the holding capacitor Ch. Here, the first boosting signal may be supplied for a longer period than the scan carry signal and/or the initialization carry signal, so that the holding capacitor Ch may stably store a voltage corresponding to the first boosting signal.

When the sampling signal SAM_S is supplied, the third transistor T3 and the fourth transistor T4 not included in the corresponding stage circuit, for example, included in the remaining stage circuits, may also be turned on.

When the third transistor T3 and the fourth transistor T4 are turned on, the first voltage control line VCG1 included in the remaining stage circuits may be electrically connected to the second electrode of the holding capacitor Ch. In this case, the first boosting signal is not supplied to the first voltage control line VCG1 included in the remaining stage circuits, and thus a voltage corresponding to the turn-off of the third transistor T3 and the fourth transistor T4 may be stored in the holding capacitor Ch.

Thereafter, the second scan carry signal SCCRi+1 may be input to the second scan carry input terminal SCIN2 and the second initialization carry signal SSCRi+1 may be input to the second initialization carry input terminal SSIN2.

When the second scan carry signal SCCRi+1 is input, the twenty-first transistor T21 and the twenty-second transistor T22 may be turned on. When the twenty-first transistor T21 and the twenty-second transistor T22 are turned on, the voltage of the third power VGL1 may be supplied to the first node Q1. Then, the first node Q1 may be set to a low voltage.

When the first node Q1 is set to a low voltage, the thirty-eighth transistor T38 and the thirty-ninth transistor T39 may be turned off. In this case, the gate electrode of the fortieth transistor T40 is raised to the voltage of the second power VGH2 by the thirty-sixth transistor T36 and the thirty-seventh transistor T37 diode-connected, and thus the fortieth transistor T40 may be turned on. When the fortieth transistor T40 is turned on, a voltage (e.g., a high voltage) of the second power VGH2 may be supplied to the second node QB1.

When the voltage of the second node QB1 is set to a high voltage, the twenty-ninth transistor T29 and the thirtieth transistor T30 may be turned on. When the twenty-ninth transistor T29 and the thirtieth transistor T30 are turned on, a voltage of the third power VGL1 may be supplied to the first node Q1, and thus the first node Q1 may maintain a low voltage.

When the second initialization carry signal SSCRi+1 is input, the nineteenth transistor T19 and the twentieth transistor T20 may be turned on. When the nineteenth transistor T19 and the twentieth transistor T20 are turned on, the voltage of the third power VGL1 may be supplied to the third node Q2. Then, the third node Q2 may be set to a low voltage.

When the third node Q2 is set to a low voltage, the thirty-third transistor T33 and the thirty-fourth transistor T34 may be turned off. In this case, the gate electrode of the thirty-fifth transistor T35 is raised to the voltage of the second power VGH2 by the thirty-first transistor T31 and the thirty-second transistor T32 diode-connected, and thus the thirty-fifth transistor T35 may be turned on. When the thirty-fifth transistor T35 is turned on, a voltage (e.g., a high voltage) of the second power VGH2 may be supplied to the fourth node QB2.

When the voltage of the fourth node QB2 is set to a high voltage, the twenty-fifth transistor T25 and the twenty-sixth transistor T26 may be turned on. When the twenty-fifth transistor T25 and the twenty-sixth transistor T26 are turned on, a voltage of the third power VGL1 may be supplied to the third node Q2, and thus the third node Q2 can maintain a low voltage.

The initialization control signal INT_C may be input to the initialization terminal INTIN during the sensing period. When the initialization control signal INT_C is input to the initialization terminal INTIN, the fifth transistor T5, the sixth transistor T6, the twelfth transistor T12, and the fourteenth transistor T14 included in all stage circuits may be turned on. Then, when the initialization control signal INT_C is input to the initialization terminal INTIN, the control transistors MC and MCa included in all the stage circuits may be turned on.

The first transistor T1 and the second transistor T2 of the remaining stages in which the holding capacitor Ch is charged with the turn-off voltage remain in the turn-off state. In this case, the first controller 410 and the second controller 410a may be electrically disconnected from the first power input terminal VIN1, thereby reducing or preventing unnecessary power consumption.

The first transistor T1 and the second transistor T2 of the corresponding stage circuit in which the holding capacitor Ch is charged with a turn-on voltage may be turned on. When the first transistor T1 is turned on, the voltage of the first power VGH1 may be supplied to the connection control lines SCG1 and SCG2 via the control transistors MC and MCa. Then, the switching transistors MSa to MSk and MSaa to MSka connected to the connection control lines SCG1 and SCG2 may be turned on. When the switching transistors MSa to MSk and MSaa to MSka are turned on, the local nodes Q1a to Q1k and Q2a to Q2k may be connected to the first node Q1 or the third node Q2.

When the second transistor T2 is turned on, a voltage of the first power VGH1 may be supplied to the first node Q1 and the second node Q2. Then, because the eleventh transistor T11 and the thirteenth transistor T13 are turned on by the voltage of the seventh node N7, the voltage of the third power VGL1 may be supplied to the second node QB1 and the fourth node QB2.

Thereafter, at least one among the scan clock signals SC_CKa to SC_CKk and at least one among initialization clock signals SS_CKa to SS_CKk may be input to a corresponding stage. For example, any one among the scan clock signals SC_CKa to SC_CKk and any one among the initialization clock signals SS_CKa to SS_CKk supplied to a corresponding stage may be supplied as the enable scan signal SC of the corresponding horizontal line and the enable initialization signal SS for a corresponding horizontal line during the sensing period.

That is, the stage circuit according to the embodiments of the present disclosure may randomly supply the enable scan signal SC and the enable initialization signal SS to a corresponding horizontal line during the sensing period while controlling the supply timing of the sampling signal SAM_S. Thereafter, the scan reset signal RST_SC, the initialization reset signal RST_SS, and the like may be supplied to initialize the stage circuit.

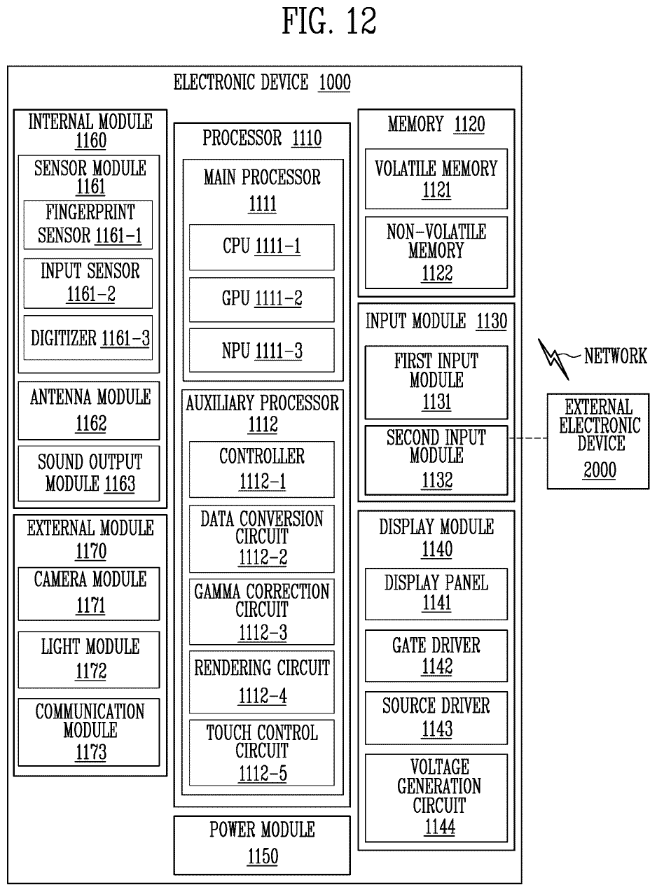

FIG. 12 is a diagram illustrating an electronic device according to one or more embodiments of the present disclosure.

Referring to FIG. 12, an electronic device 1000 according to one or more embodiments of the present disclosure outputs various information through a display module 1140. When the processor 1110 executes an application stored in a memory 1120, the display module 1140 provides application information to a user through a display panel 1141.

A processor 1110 obtains an external input through an input module 1130 or a sensor module 1161, and executes an application corresponding to the external input. For example, when the user selects a camera icon (or a camera application icon) displayed on the display panel 1141, the processor 1110 obtains a user input through an input sensor 1161-2 and activates a camera module 1171. The processor 1110 transmits image data corresponding to a captured image acquired through the camera module 1171 to the display module 1140. The display module 1140 may display an image corresponding to the captured image through the display panel 1141.

For another example, when personal information authentication is executed in the display module 1140, a fingerprint sensor 1161-1 acquires input fingerprint information as input data. The processor 1110 compares the input data acquired through the fingerprint sensor 1161-1 with authentication data stored in the memory 1120, and executes an application according to a comparison result. The display module 1140 may display information executed according to a logic of the application through the display panel 1141. The fingerprint sensor 1161-1 may be arranged to acquire fingerprint information in the entire area of the display module 1140 (or the display panel 1141).

For another example, when a music streaming icon displayed on the display module 1140 is selected, the processor 1110 obtains the user input through the input sensor 1161-2 and activates a music streaming application stored in the memory 1120. When a music execution command is input in the music streaming application, the processor 1110 activates a sound output module 1163 to provide sound information corresponding to the music execution command to the user.

In the foregoing, the operation of the electronic device 1000 has been briefly described. Hereinafter, a configuration of the electronic device 1000 will be described in detail. Some of the components of the electronic device 1000 to be described later may be integrated and provided as one component, and one component may be provided separately as two or more components.

The electronic device 1000 may communicate with an external electronic device 2000 through a network (e.g., a near field communication network or a far field communication network). According to one or more embodiments, the electronic device 1000 may include the processor 1110, the memory 1120, the input module 1130, the display module 1140, a power module 1150, an internal module 1160, and an external module 1170. According to one or more embodiments, in the electronic device 1000, at least one of the above-described components may be omitted, or one or more other components may be added. According to one or more embodiments, some of the above-described components (e.g., the sensor module 1161, an antenna module 1162, or the sound output module 1163) may be integrated into another component (e.g., the display module 1140).

The processor 1110 may execute software to control at least one other component (e.g., a hardware or software component) of the electronic device 1000 coupled to the processor 1110, and may perform various data processing or computations. According to one or more embodiments, as at least part of data processing or computation, the processor 1110 may store instructions or data received from other components (e.g., the input module 1130, the sensor module 1161, or a communication module 1173) in a volatile memory 1121, process the instructions or the data stored in the volatile memory 1211, and store result data in the non-volatile memory 1122.

The processor 1110 may include a main processor 1111 and an auxiliary processor 1112. The main processor 1111 may include a central processing unit (CPU) 1111-1. The main processor 1111 may further include any one or more of a graphics processing unit 1111-2 (GPU), a communication processor (CP), and an image signal processor (ISP). The main processor 1111 may further include a neural processing unit (NPU) 111-3. The neural network processing unit 1111-3 is a processor specialized in processing an artificial intelligence model, and the artificial intelligence model may be generated through machine learning. The artificial intelligence model may include a plurality of artificial neural network layers. The artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-networks, or a combination of two or more of the above, but is not limited to the above examples. The artificial intelligence model may include, in addition to or as an alternative to, a software structure in addition to the hardware structure. At least two of the above-described processing units and processors may be implemented in one integrated configuration (e.g., a single chip), or each may be implemented in an independent configuration (e.g., a plurality of chips).

The auxiliary processor 1112 may include a controller 1112-1. The controller 1112-1 may include an interface conversion circuit and a timing control circuit. For example, the auxiliary processor 1112 may include the timing controller 140 shown in FIG. 1. At least some functions (or configurations) of the timing controller 140 may be included in the controller 1112-1, a data conversion circuit 1112-2, a gamma correction circuit 1112-3, a rendering circuit 1112-4, and the like.

The controller 1112-1 receives an image signal from the main processor 1111, converts a data format of the image signal to conform to an interface specification with the display module 1140, and outputs the image data. The controller 1112-1 may output various control signals suitable for driving the display module 1140.

The auxiliary processor 1112 may further include the data conversion circuit 1112-2, the gamma correction circuit 1112-3, the rendering circuit 1112-4, a touch control circuit 1112-5, and the like. The data conversion circuit 1112-2 may receive the image data from the controller 1112-1, and may compensate the image data so that an image is displayed with a desired luminance according to a characteristic of the electronic device 1000 or a user's setting, or may convert the image data to reduce power consumption or compensate for an afterimage.

The gamma correction circuit 1112-3 may convert the image data, a gamma reference voltage, or the like so that the image displayed on the electronic device 1000 has a desired gamma characteristic. The rendering circuit 1112-4 may receive the image data from the controller 1112-1 and render the image data in consideration of a pixel arrangement of the display panel 1141 applied to the electronic device 1000.

The touch control circuit 1112-5 may supply a touch signal to the input sensor 1161-2 and receive a sensing signal from the input sensor 1161-2 in response to the touch signal.

At least one among the data conversion circuit 1112-2, the gamma correction circuit 1112-3, the rendering circuit 1112-4, and the touch control circuit 1112-5 may be integrated into another component (e.g., the main processor 1111 or the controller 1112-1). At least one among the data conversion circuit 1112-2, the gamma correction circuit 1112-3, and the rendering circuit 1112-4 may be integrated into a source driver 1143 described below.

The memory 1120 may store various data used by at least one component of the electronic device 1000 (e.g., the processor 1110 or the sensor module 1161) and input data or output data for instructions related to the various data. Various setting data corresponding to a user's setting may be stored in the memory 1120. The memory 1120 may include at least one among a volatile memory 1121 and a non-volatile memory 1122.

The input module 1130 may receive commands or data to be used for components of the electronic device 1000 (e.g., the processor 1110, the sensor module 1161, or the sound output module 1163) from outside the electronic device 1000, such as the user or the external electronic device 2000.

The input module 1130 may include a first input module 1131 to which a command or data is input from the user, and a second input module 1132 to which the command or the data is input from the external electronic device 2000. The first input module 1131 may include a microphone, a mouse, a keyboard, a key (e.g., a button), or a pen (e.g., a passive pen or an active pen). The second input module 1132 may support a designated protocol that can be connected to the external electronic device 2000 by wire or wirelessly. According to one or more embodiments, the second input module 1132 may include a high-definition multimedia interface (HDMI), a universal serial bus (USB) interface, an SD card interface, or an audio interface. The second input module 1132 may include a connector that can be physically connected to the external electronic device 2000, for example, an HDMI connector, a USB connector, an SD card connector, or an audio connector (e.g., a headphone connector).

The display module 1140 provides information to the user visually. The display module 1140 may include the display panel 1141, a gate driver 1142, a source driver 1143, and a voltage generation circuit 1144. The display module 1140 may further include a window, a chassis, and a bracket for protecting the display panel 1141. The display module 1140 may include at least some components of the display device illustrated in FIG. 1.

The display panel 1141 (or display) may include a liquid crystal display panel, an organic light-emitting display panel, or an inorganic light-emitting display panel. The type of the display panel 1141 is not particularly limited. The display panel 1141 may be a rigid type or a flexible type capable of rolling or folding. The display module 1140 may further include a supporter, a bracket, a heat dissipation member, or the like that supports the display panel 1141. The display panel 1141 may include the pixel 110 illustrated in FIG. 1.

The gate driver 1142 may be mounted on the display panel 1141 as a driving chip. The gate driver 1142 may be integrated into the display panel 1141. For example, the gate driver 1142 may include an ASG (Amorphous Silicon TFT Gate driver circuit), an LTPS (Low Temperature Polycrystalline Silicon) TFT gate driver circuit, or an OSG (Oxide Semiconductor TFT Gate driver circuit) internalized in the display panel 1141. The gate driver 1142 receives a control signal from the controller 1112-1 and outputs scan signals to the display panel 1141 in response to the control signal. The gate driver 1142 may include the scan driver 130 shown in FIG. 1. For example, the gate driver 1142 may include the stage circuit illustrated in FIG. 3. For example, the gate driver 1142 may include the driver 402, the boosters 404 and 404a, the carry outputs 406 and 406a, the outputs 408a to 408k and 408aa to 408ka, the connectors 412a to 412k and 412aa to 412ka, the controllers 410 and 410a, and resets 414 and 414a illustrated in FIGS. 4A and 4B.

The display module 1140 may further include a light-emitting driver. The light emission driver outputs a light emission control signal to the display panel 1141 in response to the control signal received from the controller 1112-1. The light emission driver may be formed to be distinguished from the gate driver 1142 or may be integrated into the gate driver 1142.

The source driver 1143 receives a control signal from the controller 1112-1, converts the image data into an analog voltage (e.g., a data signal) in response to the control signal, and then outputs the data signal to the display panel 1141. The source driver 1143 may include the data driver 120 shown in FIG. 1.

The source driver 1143 may be integrated into other components (e.g., controller 1112-1). The functions of the interface conversion circuit and the timing control circuit of the controller 1112-1 described above may be integrated into the source driver 1143. The voltage generation circuit 1144 may output various voltages suitable for driving the display panel 1141.

In one or more embodiments, the source driver 1143 may convert data corresponding to a red (R), a green (G), and a blue (B) included in the image data received from the processor 1110 into a red data signal (or data voltage), a green data signal, and a blue data signal, and provide them to a plurality of pixel columns included in the display panel 1141 during one horizontal period.

The power module 1150 supplies power to the components of the electronic device 1000. The power module 1150 may include a battery that charges a power voltage. The battery may include a non-rechargeable primary battery, a rechargeable secondary battery, or a fuel cell. The power module 1150 may include a power management integrated circuit (PMIC). The PMIC supplies optimized power to each of the above-described module and a module to be described later. The power module 1150 may include a wireless power transmission/reception member electrically connected to the battery. The wireless power transmission/reception member may include a plurality of antenna radiators in the form of coils. In one or more embodiments, at least some configurations of the power module 1150 and the voltage generation circuit 1144 may be provided integrated into one. For example, the voltage generation circuit 1144 may be included in the power module 1150.

The electronic device 1000 may further include the internal module 1160 and the external module 1170. The internal module 1160 may include the sensor module 1161, the antenna module 1162, and the sound output module 1163. The external module 1170 may include a camera module 1171, a light module 1172, and a communication module 1173.

The sensor module 1161 may detect an input by the user's body or an input by a pen among the first input module 1131, and may generate an electrical signal or a data value corresponding to the input. The sensor module 1161 may include at least one or more among a fingerprint sensor 1161-1, an input sensor 1161-2, and a digitizer 1161-3.

The fingerprint sensor 1161-1 may generate a data value corresponding to the user's fingerprint.

The input sensor 1161-2 may generate a data value corresponding to coordinate information of the input by a user's body or the input by a pen. The input sensor 1161-2 generates a capacitance change amount by the input as a data value. The input sensor 1161-2 may detect an input by a passive pen or transmit and receive data to and from an active pen.

The input sensor 1161-2 may measure a bio-signal, such as blood pressure, moisture, or body fat. For example, when the user contacts a part of the body with the sensor layer or the sensing panel and does not move for a certain period of time, based on a change in an electric field caused by the part of the body, the input sensor 1161-2 may sense the bio-signal and output information desired by the user to the display module 1140.

The digitizer 1161-3 may generate a data value corresponding to coordinate information of the input by the pen. The digitizer 1161-3 generates an electromagnetic change amount by the input as a data value. The digitizer 1161-3 may sense the input by the passive pen or transmit and receive data to and from the active pen.

At least one among the fingerprint sensor 1161-1, the input sensor 1161-2, and the digitizer 1161-3 may be implemented as a sensor layer formed on the display panel 1141 through a continuous process. At least one among the fingerprint sensor 1161-1, the input sensor 1161-2, and the digitizer 1161-3 may be located on an upper side of the display panel 1141, and any one among the fingerprint sensor 1161-1, the input sensor 1161-2, and/or the digitizer 1161-3, for example, the digitizer 1161-3 may be located under the display panel 1141.

At least two or more among the fingerprint sensor 1161-1, the input sensor 1161-2, and the digitizer 1161-3 may be formed to be integrated into one sensing panel through the same process. In the case of being integrated with the sensing panel, the sensing panel may be located between the display panel 1141 and a window located above the display panel 1141. According to one or more embodiments, the sensing panel may be located on the window, and the position of the sensing panel is not particularly limited.

At least one among the fingerprint sensor 1161-1, the input sensor 1161-2, and the digitizer 1161-3 may be embedded in the display panel 1141. That is, at least one among the fingerprint sensor 1161-1, the input sensor 1161-2, and the digitizer 1161-3 may be simultaneously formed through a process of forming elements (e.g., a light-emitting element, a transistor, and the like) included in the display panel 1141.

The sensor module 1161 may generate an electrical signal or a data value corresponding to an internal state or an external state of the electronic device 1000. The sensor module 1161 may further include, for example, a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 1162 may include one or more antennas for transmitting or receiving a signal or power to or from the outside. According to one or more embodiments, the communication module 1173 may transmit a signal to or receive a signal from an external electronic device through an antenna suitable for a communication method. The antenna pattern of the antenna module 1162 may be integrated into one configuration of the display module 1140 (e.g., the display panel 1141), the input sensor 1161-2, or the like.

The sound output module 1163 may be a device for outputting a sound signal to the outside of the electronic device 1000, and may include, for example, a speaker used for general purposes, such as multimedia playback or recording playback, and a receiver used exclusively for phone reception. According to one or more embodiments, the receiver may be formed integrally with or separately from the speaker. A sound output pattern of the sound output module 1163 may be integrated with the display module 1140.

The camera module 1171 may capture a still image and a moving image. According to one or more embodiments, the camera module 1171 may include one or more lenses, an image sensor, or an image signal processor. The camera module 1171 may further include an infrared camera capable of measuring the presence or absence of a user, a position of the user, a gaze of the user, and the like.

The light module 1172 may provide light. The light module 1172 may include a light-emitting diode or a xenon lamp. The light module 1172 may operate in conjunction with the camera module 1171 or may operate independently.

The communication module 1173 may support establishment of a wired or wireless communication channel between the electronic device 1000 and the external electronic device 2000, and communication through the established communication channel. The communication module 1173 may include one or both of a wireless communication module, such as a cellular communication module, a near field communication module, or a global navigation satellite system (GNSS) communication module and a wired communication module, such as a local area network (LAN) communication module or a power line communication module. The communication module 1173 may communicate with the external electronic device 2000 through a near field communication network, such as Bluetooth® (Bluetooth® being a registered trademark of Bluetooth Sig, Inc., Kirkland, WA), Wi-Fi Direct™ (Wi-Fi Direct™ being a registered trademark of the non-profit Wi-Fi Alliance), or IrDA (infrared data association) or a cellular network, the Internet, or a long-range communication network, such as a computer network (e.g., a LAN or a WAN). The various types of communication modules 1173 described above may be implemented as one chip or may be implemented as separate chips.

The input module 1130, the sensor module 1161, the camera module 1171, and the like may be utilized to control the operation of the display module 1140 in conjunction with the processor 1110.

The processor 1110 outputs a command or data to the display module 1140, the sound output module 1163, the camera module 1171, or the light module 1172 based on the input data received from the input module 1130. For example, the processor 1110 may generate image data in response to input data applied through a mouse, an active pen, or the like and output the image data to the display module 1140, or may generate command data in response to the input data and output the command data to the camera module 1171 or the light module 1172. In case that input data is not received from the input module 1130, the processor 1110 may switch the operation mode of the electronic device 1000 to a low power mode or a sleep mode to reduce power consumed by the electronic device 1000.

The processor 1110 outputs a command or data to the display module 1140, the sound output module 1163, the camera module 1171, or the light module 1172 based on the sensing data received from the sensor module 1161. For example, the processor 1110 may compare the authentication data authorized by the fingerprint sensor 1161-1 with the authentication data stored in the memory 1120, and then execute an application according to the comparison result. The processor 1110 may execute a command or output corresponding image data to the display module 1140 based on the sensing data sensed by the input sensor 1161-2 or the digitizer 1161-3. In case that the sensor module 1161 includes a temperature sensor, the processor 1110 may receive temperature data for a measured temperature from the sensor module 1161, and further perform luminance correction or the like on the image data based on the temperature data.

The processor 1110 may receive measurement data on presence or absence of the user, a position of the user, and a gaze of the user from the camera module 1171. The processor 1110 may further perform luminance correction or the like on the image data based on the measurement data. For example, the processor 1110 that determines the presence or absence of the user through the input from the camera module 1171 may output the image data whose luminance is corrected to the display module 1140 through the data conversion circuit 1112-2 or the gamma correction circuit 1112-3.

Some of the above components may be connected to each other through a communication method between peripheral devices, for example, a bus, a general purpose input/output (GPI), a serial peripheral interface (SPI), a mobile industry processor interface (MIPI), or a Ultra path interconnect (UPI) link to exchange signals (e.g., commands or data) with each other. The processor 1110 may communicate with the display module 1140 through an interface promised to each other, for example, any one of the above-described communication schemes may be used, and is not limited to the communication scheme described above.

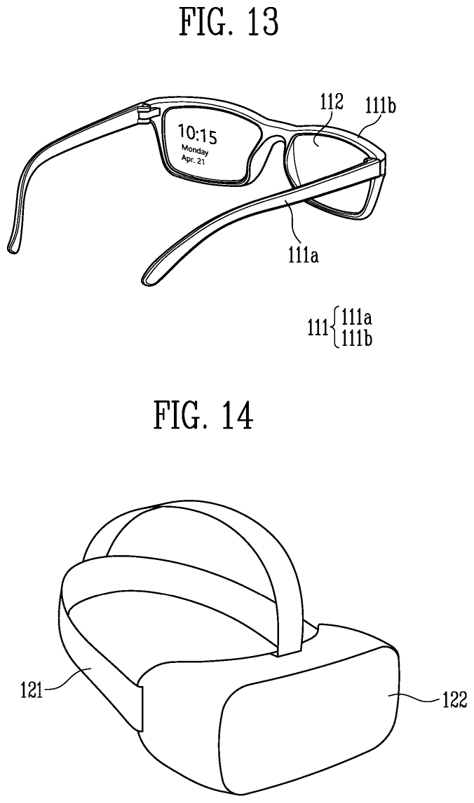

FIGS. 13 to 16 are diagrams illustrating an electronic device according to various embodiments.

Referring to FIG. 13, a display device according to one or more embodiments of the present disclosure may be applied to a smart glass. The smart glass may include a frame 111 and a lens (e.g., lens unit) 112. The smart glass is a wearable electronic device that may be worn on a user's face, and may have a structure in which a part of the frame 111 is folded or unfolded. For example, the smart glass may be a wearable device for augmented reality (AR).

The frame 111 may include a housing 111b supporting the lens 112 and a leg 111a for wearing by a user. The leg 111a may be connected to the housing 111b by a hinge and folded or unfolded.

A battery, a touch pad, a microphone, and/or a camera may be embedded in the frame 111. In addition, a projector that outputs light and/or a processor that controls an optical signal or the like may be embedded in the frame 111.

The lens 112 may be an optical member that transmits light or reflects light. The lens 112 may include glass and/or a transparent synthetic resin or the like.

The display device according to one or more embodiments of the present disclosure may be applied to the lens 112. For example, the user may recognize an image displayed by an optical signal transmitted from a projector of the frame 111 through the lens 112. For example, the user may recognize information, such as a time and a date displayed on the lens 112.

Referring to FIG. 14, the display device according to one or more embodiments of the present disclosure may be applied to a head-mounted display (HMD). The head-mounted display may include a head-mounted band 121 and a display housing case 122. For example, the head-mounted display may be a wearable electronic device wearable on a user's head.

The head-mounting band 121 may be connected to the display housing case 122 to fix the display housing case 122. The head-mounted band 121 may include a horizontal band and a vertical band to secure the head-mounted display to the user's head, the horizontal band may surround a side of the user's hair, and the vertical band may surround an upper portion of a user's hair. However, it is not necessarily limited thereto, and the head-mounting band 121 may be implemented in the form of a spectacle frame or a helmet.

The display housing case 122 houses a display device and may include at least one lens. At least one lens may provide an image to a user. For example, the display device according to one or more embodiments of the present disclosure may be applied to a left-eye lens and a right-eye lens implemented in the display housing case 122.

Referring to FIG. 15, the display device according to one or more embodiments of the present disclosure may be applied to a smart watch. The smart watch may include a display 131 and a strap (e.g., strap unit) 133. The smart watch is a wearable electronic device, and the strap 133 may be mounted on a user's wrist. The display device according to one or more embodiments of the present disclosure may be applied to the display 131. For example, the display 131 may provide image data including information, such as time and date.

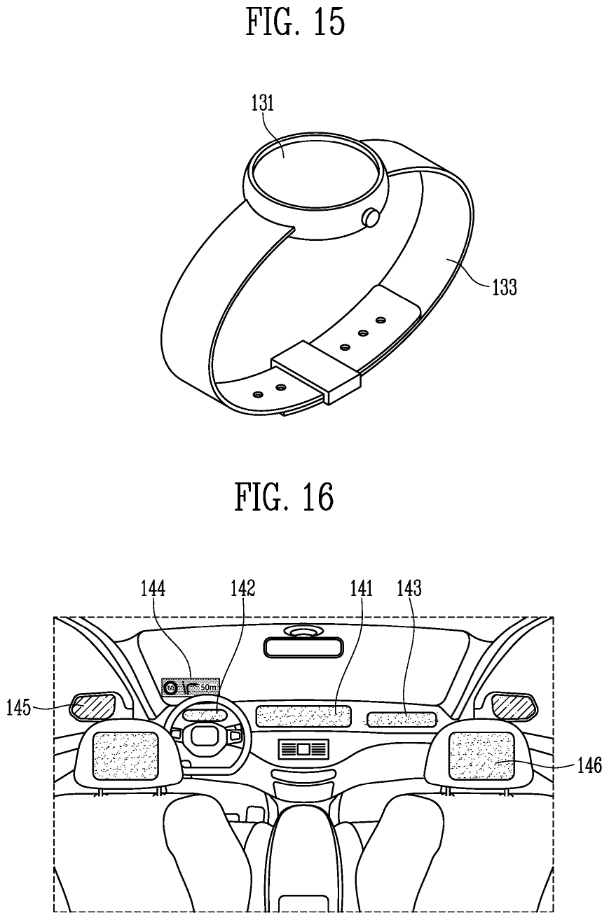

Referring to FIG. 16, the display device according to one or more embodiments of the present disclosure may be applied to an automatic display. For example, the automatic display may refer to an electronic device provided inside and outside the vehicle to provide image data.

For example, the display device according to one or more embodiments of the present disclosure may be applied to at least one among an infotainment panel 141, a cluster 142, a co-driver display 143, a head-up display 144, a side mirror display 145, and a rear seat display 146 provided in a vehicle.

Although described above with reference to embodiments of the present disclosure, it will be understood that those skilled in the art may variously modify and change the present disclosure without departing from the spirit and scope of the present disclosure described in the claims, with functional equivalents thereof to be included therein.

What is claimed is:

1. A stage circuit comprising:
a driver configured to control a voltage of a first node, a voltage of a second node, a voltage of a third node, and a voltage of a fourth node;
a first driving circuit connected to the first node and to the second node, and configured to supply a scan signal to first output terminals based on voltages of first local nodes configured to be controlled corresponding to the voltage of the first node;
a second driving circuit connected to the third node and to the fourth node, and configured to supply an initialization signal to second output terminals based on voltages of second local nodes configured to be controlled corresponding to the voltage of the third node;
first connectors in the first driving circuit and respectively between the first node and the first local nodes;
second connectors in the second driving circuit and respectively between the third node and the second local nodes;
a first controller in the first driving circuit and configured to control the first connectors;
a second controller in the second driving circuit and configured to control the second connectors; and
a first transistor having a first electrode connected to the first controller and to the second controller, and a second electrode connected to a first power input terminal for receiving a first power.

2. The stage circuit of claim 1, wherein the driver comprises:
a holding capacitor having a first electrode connected to the first power input terminal; and
a third transistor and a fourth transistor connected in series between a first voltage control line in the first driving circuit and a second electrode of the holding capacitor, and having a gate electrode connected to a sampling input terminal for receiving a sampling signal.

3. The stage circuit of claim 2, wherein a gate electrode of the first transistor is connected to the second electrode of the holding capacitor.

4. The stage circuit of claim 2, further comprising a second transistor connected between the first power input terminal and a common terminal of the third and fourth transistors, and having a gate electrode connected to a second electrode of the holding capacitor.

5. The stage circuit of claim 2, wherein the first driving circuit comprises:
the first controller connected to the first power input terminal, to a second power input terminal for receiving a second power, to a first scan carry input terminal for receiving a first scan carry signal, to a second scan carry input terminal for receiving the second scan carry signal, and to an initialization terminal for receiving an initialization control signal, and configured to control a voltage of a first connection control line;
a first booster connected to a boosting clock input terminal for receiving a first boosting clock signal and to a third power input terminal for receiving a third power, and configured to control the voltage of the first voltage control line based on the voltage of the first node and the voltage of the second node;
a first carry output connected to a scan carry clock input terminal for receiving a first scan carry clock signal and to the third power input terminal, and configured to output a scan carry signal to a first carry output terminal based on the voltage of the first node and the voltage of the second node;
first outputs connected to scan clock input terminals for receiving one of scan clock signals and to a fourth power input terminal for receiving a fourth power, and configured to output the scan signal to the first output terminals based on the voltages of the first local nodes and the voltage of the second node;
the first connectors configured to control an electrical connection between the first local nodes and the first node based on the voltage of the first connection control line; and
a first reset connected between the first connection control line and a fifth power input terminal for receiving a fifth power, and configured to control an electrical connection between the first connection control line and the fifth power input terminal based on the voltage of the second node.

6. The stage circuit of claim 5, wherein the first controller further comprises:
a control transistor connected between the first connection control line and the first electrode of the first transistor, and having a gate electrode connected to the initialization terminal;
a first control transistor connected between the first power input terminal and the first connection control line, and having a gate electrode connected to the first scan carry input terminal;
a second control transistor connected between the second power input terminal and the first connection control line, and having a gate electrode connected to the first voltage control line; and
a third control transistor connected between the second power input terminal and the first connection control line, and having a gate electrode connected to the second scan carry input terminal.

7. The stage circuit of claim 5, wherein each of the first connectors comprises:
a switching transistor connected between one of the first local nodes and the first node, and having a gate electrode connected to the first connection control line; and
a boosting capacitor connected between the one of the first local nodes and the first voltage control line.

8. The stage circuit of claim 5, wherein the first booster comprises:
a first boosting transistor connected between the boosting clock input terminal and the first voltage control line, and having a gate electrode connected to the first node;
a second boosting transistor connected between the third power input terminal and the first voltage control line, and having a gate electrode connected to the second node; and
a first capacitor connected between the first node and the first voltage control line.

9. The stage circuit of claim 5, wherein the first carry output comprises:
a first carry transistor connected between the scan carry clock input terminal and the first carry output terminal, and having a gate electrode connected to the first node; and
a second carry transistor connected between the first carry output terminal and the third power input terminal, and having a gate electrode connected to the second node.

10. The stage circuit of claim 5, wherein the first outputs comprise:
a first output transistor connected between a corresponding one of the scan clock input terminals and a corresponding one of the first output terminals, and having a gate electrode connected to a corresponding one of the first local nodes; and
a second output transistor connected between the fourth power input terminal and the corresponding one of the first output terminals, and having a gate electrode connected to the second node.

11. The stage circuit of claim 5, wherein the first reset comprises at least one reset transistor connected between the first connection control line and the fifth power input terminal, and having a gate electrode connected to the second node.

12. The stage circuit of claim 1, wherein the second driving circuit comprises:
the second controller connected to the first power input terminal, to a second power input terminal for receiving a second power, to a first initialization carry input terminal for receiving a first initialization carry signal, to a second initialization carry input terminal for receiving a second initialization carry signal, and to an initialization terminal for receiving an initialization control signal, and configured to control a voltage of a second connection control line;
a second booster connected to a boosting clock input terminal for receiving a first boosting clock signal and to a third power input terminal for receiving a third power, and configured to control a voltage of a second voltage control line based on the voltage of the third node and the voltage of the fourth node;
a second carry output connected to an initialization carry clock input terminal for receiving a first initialization carry clock signal and to the third power input terminal, and configured to output an initialization carry signal to a second carry output terminal based on the voltage of the third node and the voltage of the fourth node;
second outputs connected to initialization clock input terminals for receiving a corresponding one of initialization clock signals and to a fourth power input terminal for receiving a fourth power, and configured to output the initialization signal to the second output terminals based on the voltages of the second local nodes and the voltage of the fourth node;
the second connectors configured to control an electrical connection between the second local nodes and the third node based on the voltage of the second connection control line; and
a second reset connected between the second connection control line and a fifth power input terminal for receiving a fifth power, and configured to control an electrical connection between the second connection control line and the fifth power input terminal based on the voltage of the fourth node.

13. The stage circuit of claim 12, wherein the second controller further comprises:
a control transistor connected between the second connection control line and the first electrode of the first transistor, and having a gate electrode connected to the initialization terminal;
a first control transistor connected between the first power input terminal and the second connection control line, and having a gate electrode connected to the first initialization carry input terminal;
a second control transistor connected between the second power input terminal and the second connection control line, and having a gate electrode connected to the second voltage control line; and
a third control transistor connected between the second power input terminal and the second connection control line, and having a gate electrode connected to the second initialization carry input terminal.

14. The stage circuit of claim 12, wherein the second connectors comprise:
a switching transistor connected between a corresponding one of the second local nodes and the third node, and having a gate electrode connected to the second connection control line; and
a boosting capacitor connected between the corresponding one of the second local nodes and the second voltage control line.

15. The stage circuit of claim 12, wherein the second booster comprises:
a first boosting transistor connected between the boosting clock input terminal and the second voltage control line, and having a gate electrode connected to the third node;
a second boosting transistor connected between the third power input terminal and the second voltage control line, and having a gate electrode connected to the fourth node; and
a first capacitor connected between the third node and the second voltage control line.

16. The stage circuit of claim 12, wherein the second carry output comprises:
a first carry transistor connected between the initialization carry clock input terminal and the second carry output terminal, and having a gate electrode connected to the third node; and
a second carry transistor connected between the second carry output terminal and the third power input terminal, and having a gate electrode connected to the fourth node.

17. The stage circuit of claim 12, wherein the second outputs comprise:
a first output transistor connected between a corresponding one of the initialization clock input terminals and a corresponding one of the second output terminals, and having a gate electrode connected to a corresponding one of the second local nodes; and
a second output transistor connected between the fourth power input terminal and the corresponding one of the second output terminals, and having a gate electrode connected to the fourth node.

18. The stage circuit of claim 12, wherein the second reset comprises at least one reset transistor connected between the second connection control line and the fifth power input terminal, and having a gate electrode connected to the fourth node.

19. A display device comprising:
pixels connected with scan lines, initialization lines, and data lines; and
a scan driver comprising stage circuits configured to provide a scan signal to the scan lines and an initialization signal to the initialization lines during a driving period, and to provide the scan signal to at least one first scan line among the scan lines and the initialization signal to at least one first initialization line among the initialization lines during a sensing period,
wherein at least one stage circuit of the stage circuits comprises:
a driver configured to control a voltage of a first node, a voltage of a second node, a voltage of a third node, and a voltage of a fourth node, and comprising a holding capacitor configured to be charged when an enable scan signal is output from the stage circuit and a sampling signal is input;
a first driving circuit configured to output the scan signal, and comprising first local nodes configured to be controlled based on the voltage of the first node, first connectors respectively connected between the first node and the first local nodes, and a first controller configured to control the first connectors;
a second driving circuit configured to output the initialization signal, and comprising second local nodes configured to be controlled based on the voltage of the third node, second connectors respectively connected between the third node and the second local nodes, and a second controller configured to control the second local nodes; and
a first transistor comprising a first electrode connected to the first controller and to the second controller, a second electrode connected to a first power input terminal, and a gate electrode connected to a second electrode of the holding capacitor.

20. An electronic device comprising:
a processor; and
a display module configured to display an image based on image data provided from the processor, the display module comprising:
pixels connected with scan lines, initialization lines, and data lines; and
a scan driver comprising stage circuits configured to provide a scan signal to the scan lines and an initialization signal to the initialization lines during a driving period, and to provide the scan signal to at least one first scan line among the scan lines and the initialization signal to at least one first initialization line among the initialization lines during a sensing period,
wherein at least one stage circuit of the stage circuits comprises:
a driver configured to control a voltage of a first node, a voltage of a second node, a voltage of a third node, and a voltage of a fourth node, and comprising a holding capacitor configured to be charged when an enable scan signal is output from the stage circuit and a sampling signal is input;
a first driving circuit configured to output the scan signal and comprising first local nodes configured to be controlled based on the voltage of the first node, first connectors respectively connected between the first node and the first local nodes, and a first controller configured to control the first connectors;
a second driving circuit configured to output the initialization signal and comprising second local nodes configured to be controlled based on the voltage of the third node, second connectors respectively connected between the third node and the second local nodes, and a second controller configured to control the second local nodes; and
a first transistor comprising a first electrode connected to the first controller and to the second controller, a second electrode connected to a first power input terminal, and a gate electrode connected to a second electrode of the holding capacitor.
